(19) United States
(12) Patent Application Publication
(10) Pub. No.: US 2018/0215871 A1
(43) Pub. Date: Aug. 2, 2018

(54) LASER-INITIATED ADDITIVE MANUFACTURING OF POLYIMIDE PRECURSOR

(71) Applicant: SABIC Global Technologies B.V., Bergen op Zoom (NL)

(72) Inventors: Viswanathan Kalyanaraman, Newburgh, IN (US); Erich Otto Teutsch, Richmond, MA (US); Thomas Hocker, Pittsfield, MA (US); Brian Price, Evansville, IN (US); Peter Zuber, Pittsfield, MA (US)

(73) Assignee: SABIC Global Technologies B.V., Bergen op Zoom (NL)

(21) Appl. No.: 15/579,345

(22) PCT Filed: Jun. 2, 2016
(86) PCT No.: PCT/IB2016/053245

§ 371 Date: Dec. 4, 2017

Related U.S. Application Data
(60) Provisional application No. 62/170,418, filed on Jun. 3, 2015.

(51) Int. Cl. C08G 73/10; B29C 64/153; C08L 79/08

(52) U.S. Cl. CPC C08G 73/1025; B29C 64/153; C08G 73/1032; C08G 73/1046; B29K 2079/08; C08G 73/106; C08G 73/1064; C08G 73/101; C08L 79/08; C08G 73/1039

(57) ABSTRACT

A system comprises a build area, a precursor feed system to feed polyimide precursor to the build area, and a laser system comprising a laser device to emit a focused energy beam onto the build area, and a laser actuator to aim the focused energy onto selected target locations of the build area in order to selectively initiate polymerization of at least a portion of the polyimide precursor into a structure including polyimide. A method comprises feeding a polyimide precursor to a build area and selectively directing a focused energy beam to the build area to selectively initiate polymerization of at least a portion of the polyimide precursor into a structure including polyimide.

### CROSS-REFERENCE TO RELATED APPLICATIONS

This application claims priority to U.S. Provisional Application No. 62/170,418 filed on Jun. 3, 2015. Additionally, the subject matter of this application is related to the U.S. Provisional Application No. 62/173,583 filed on Jun. 3, 2015, entitled “3D INK-JET PRINTING OF POLYIMIDE PRECURSOR,” filed on the same day as this application, and the U.S. Provisional Application No. 62/170,423 filed on Jun. 3, 2015, entitled “MATERIAL EXTRUSION ADDITIVE MANUFACTURING OF POLYIMIDE PRECURSOR,” filed on the same day as this application. The disclosures of all of which are incorporated by reference as if reproduced herein in their entireties.

### BACKGROUND

On-demand fabrication of articles using three-dimensional (3D) computer-assisted design (CAD) data, also referred to as additive manufacturing or 3D printing, has been improving and becoming more prevalent. 3D printing technologies can include several different technology methods. One such method is referred to as selective laser sintering, which uses a focused laser beam to heat and fuse a powder material to fabricate articles in a layer-by-layer manner.

### SUMMARY

The present disclosure describes a system for selective laser sintering or stereolithoraphy of a reactive polyimide precursor compound for rapid prototyping a polyimide layers.

The present inventors have recognized, among other things, that a problem to be solved included that selective laser sintering of polyimide materials could not be readily performed because polyimide materials do not melt with sufficiently low viscosities to allow for adequate reflow. The present subject matter described herein can provide a solution to this problem, such as by provided for selective laser sintering of a polyimide precursor compound having a lower viscosity than the final polyimide, wherein the lower viscosity of the polyimide precursor compound can allow for lower viscosity that can be more readily melted and reflowed.

The present inventors have recognized, among other things, that a problem to be solved can include adhesion between layers of a polyimide article fabricated by 3D printing. The present subject matter described herein can provide a solution to this problem, such as by providing for 3D selective laser sintering of a reactive polyimide precursor compound that can react and crosslink between layers, providing for better adhesion between layers.

The present inventors have recognized, among other things, that a problem to be solved can include undesirable void space between layers of an article fabricated by 3D selective laser sintering. The present subject matter described herein can provide a solution to this problem, such as by providing for 3D selective laser sintering of a reactive polyimide precursor compound that will provide for better reflow and adhesion between layers resulting in reduced void space.

The present inventors have recognized, among other things, that a problem to be solved can include that 3D selective laser sintering, particularly of amorphous polymer resins, can be relatively slow and require a relatively high cycle time. The present subject matter described herein can provide a solution to this problem, such as by providing for 3D selective laser sintering of a reactive polyimide precursor compound that can more easily melt compared to the final polyimide, which can provide for increased speed of printing and reduced cycle time to form an article.

### BRIEF DESCRIPTION OF THE FIGURES

FIG. 1 is a schematic diagram of an example system for fabricating a structure including polyimide by reactive selective laser sintering.

FIG. 2 is a schematic diagram of another example system for fabricating a structure including polyimide by reactive selective laser sintering.

FIG. 3 is a schematic diagram of an example system for fabricating a structure including polyimide by reactive stereolithography.

FIG. 4 is a flow diagram of an example method of forming a structure including polyimide via reactive selective laser sintering.

### DETAILED DESCRIPTION

The present disclosure describes selective laser sintering (or “SLS”) of a polyimide precursor powder by selectively aiming a laser beam or other focused energy beam at the polyimide precursor powder located within a target area to selectively melt the polyimide precursor powder and initiate polymerization of one or more polyimide precursor compounds therein to form one or more polyimide layers. The present disclosure also describes stereolithography (or “SLA”) of a polyimide precursor gel or resin by selectively aiming a laser beam or other focused energy beam at the polyimide precursor gel or resin located within a target area to selectively drive off solvent of the precursor gel or selectively initiate polymerization of one or more polyimide precursor compounds therein, or both, to form a structure including polyimide.

Amorphous resins, such as polyimides, are not currently used broadly for laser sintering or for stereolithography. For example, typically for SLS the build environment is heated very close to the melting point of the resin powder used in the system, and the powder will be fully melted by the application of a targeted heat source, such as a laser beam, that provides enough energy to fully melt the powder. However, amorphous resins demonstrate broad softening behavior when heated and therefore typically cannot be heated as close to the temperature required to flow the resin as a crystalline or semi-crystalline resin. This limits the preheating that can be done in the build chamber, and can require that more energy be applied by the targeted heat source, e.g., the laser beam, which generally translates to a slower printing process and therefore limits the use of amorphous resins.

Amorphous resins, including polyimides, are also not typically used for selective laser sintering because once they are heated to the point of flowing, their viscosity does not allow the air trapped around the powder to flow out of the melt pool. This can result in air-bubbles becoming entrapped in the printed structure, which can degrade mechanical performance. For example, amorphous non-crystalline polymeric materials, such as polyimide materials, have been impractical for SLS because amorphous non-crystalline polymers do not have a well-defined melting point and do not solidify with a long-range order typically characteristic of a crystalline polymer. Amorphous polymeric materials often have a glass transition temperature or glass transition range as opposed to a well-defined melting point, as is typical with crystalline polymers. Therefore, amorphous polymers tend to soften or melt over a wide temperature range instead of liquefying at a set melting point. Amorphous polymers also tend to have high viscosities when partially melted within the wide temperature range such that amorphous polymer powder particles will tend to maintain their shape and structure as they become fused together. This can result in the fused amorphous polymer powder leaving behind a relatively high porosity. In addition, because the amorphous polymeric material is melted incompletely, air and other gases can become trapped in the void spaces of the resulting structure. The relatively large porosity and trapped air or gas in the void spaces can lead to the resulting structures having relatively low densities and relatively low strength. Increasing laser energy to fully melt the polymer to a low enough viscosity so that the porosity can be sufficiently reduced increases the energy requirements of the process. Moreover, increasing laser energy in order to attempt to fully melt the amorphous polymer can result in polymer degradation.

Amorphous polymer materials, for example polyimides, such as polyetherimide, may also be non-ideal candidates for SLA because it can be difficult to form a gel precursor unless aggressive organic solvents that can require additional precautions for safety and health considerations, such as methylene chloride, dichlorobenzene, N-methyl pyrrolidone, dimethyl acetamide, dimethyl formamide, or tetrahydrofuran.

The present disclosure describes systems and methods that are especially useful for selective laser sintering or stereolithography of precursors that can be used to produce polyimide parts. The systems and methods described herein involve the selective application of a focused energy beam, such as a laser beam, to a polyimide precursor material, such as a polyimide precursor powder or polyimide precursor gel, comprising one or more polyimide precursor compounds to provide for polymerization of the polyimide precursor compounds to form a structure including polyimide comprising one or more polyimide layers.

### Polyimide Precursor Selective Laser Sintering System

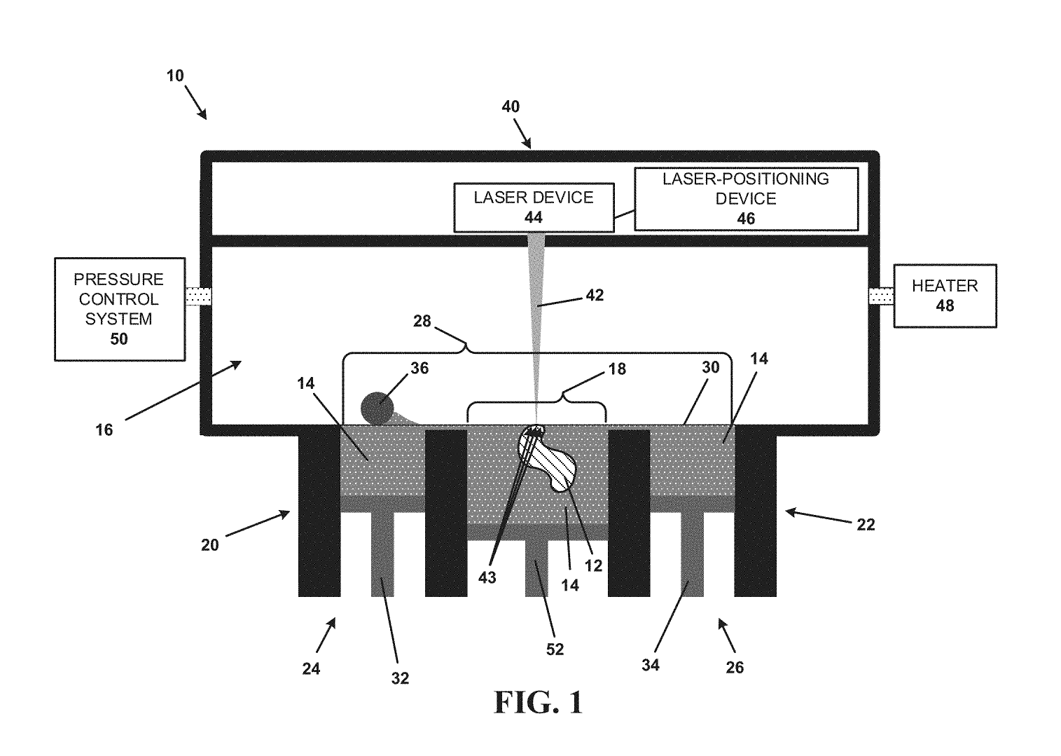

FIG. 1 shows an example selective laser sintering system 10 for fabricating a structure 12 including polyimide from a reactive polyimide precursor powder 14. The system 10 can include a target area 18 in a build chamber 16 where the structure 12 is to be built. As described in more detail below, the polyimide precursor powder 14 can comprise one or more polyimide precursor compounds that, upon application of a focused energy beam such as a laser, can melt in order to react and polymerize to form a polyimide material. The precursor powder 14 can comprise powder particles comprising at least one of one or more bisanhydride precursor compounds, one or more diamine precursor compounds, and a reaction product of one or more bisanhydride precursor compounds and one or more diamine precursor compounds. In some examples, the polyimide precursor powder 14 can comprise an oligomeric reaction product of one or more bisanhydride precursor compounds and one or more diamine precursor compounds, for example an imide oligomer formed by the reaction of the bisanhydride precursor compounds and the diamine precursor compounds. The precursor powder 14 can include a dry powder mixture of bisanhydride precursor compound powder particles and diamine precursor compound powder particles.

The system 10 can include one or more powder feed systems 20, 22 to feed the precursor powder 14 to the target area 18. A first powder feed system 20 can include a first powder cartridge 24 for precursor powder 14. The feed system 20 can include a powder moving mechanism to move the precursor powder 14 from the first powder cartridge 24 to the target area 18. A second powder feed system 22 can include a second powder cartridge 26 for precursor powder 14. The feed system 22 can include a powder moving mechanism to move the precursor powder 14 from the second powder cartridge 26 to the target area 18. The powder cartridges 24, 26 and the target area 18 can, in combination, form a powder bed 28 having an upper powder surface 30. The target area 16 can form a portion of the powder bed 28 at the upper powder surface 30, for example a central portion of the powder bed 28.

The powder moving mechanism can include a piston to push the precursor powder 14 upward toward the powder bed 28. The powder moving mechanism can include a first piston 32 positioned in the first powder cartridge 24 for the first powder feed system 20. The powder moving mechanism can include a second piston 34 positioned in the second powder cartridge 26 for the second powder feed system 22. The piston 32, 34 can push a measured amount of the precursor powder 14 upward from a corresponding powder cartridge 24, 26 to the powder bed 28. The powder moving mechanism for the feed system 20, 22 can include a powder pusher, such as a powder roller 36, which can push the precursor powder 14 that has been raised up by a piston 32, 34 from one of the powder cartridges 24, 26 onto the target area 18. The powder roller 36 can also level the precursor powder 14 so that at least the target area 18 portion of the powder bed 28 has a flat or substantially flat upper powder surface 30 presented to the laser for sintering. The powder moving mechanism can include a single powder roller 36 that can move between a plurality of powder feed systems, such as back and forth between the powder feed systems 20, 22 as shown in FIG. 1. The powder moving mechanism can include a dedicated powder roller for one or both powder feed systems 20, 22.

The system 10 can include a system 40 to emit a focused energy beam 42. For the sake of brevity, the system 40 will be referred to herein as a laser system 40 and the focused energy beam 42 will be referred to as a laser beam 42. Other focused energy beams can conceivably be used alone or in combination with a laser. The laser system 40 can be any focusable laser beam with a power output configured for various factors, including a specified heating of the precursor powder, expected particle energy absorption, scan rate, and illumination area. The laser beam 42 can have a wavelength of about 10.6 μm. The laser beam 42 can have a power output of from about 3 Watts to about 30 Watts. The laser beam 42 can have a beam width of from about 0.25 mm to about 1 mm, such as about 0.5 mm.

The laser system 40 can include a laser device 44 that will emit the laser beam 42. In some examples, the laser device 44 comprises a CO₂ laser or infrared device. A laser actuator 46 can position and direct the laser device 44 in order to aim the laser beam 42 within the target area 18. The laser actuator 46 can aim the laser beam 42 within a specified coordinate system, such as Cartesian and polar coordinate systems. CAD data can be used along with the coordinate system to direct the laser beam 42 while building one or more layers of the structure 12. The laser actuator 46 can include a memory device to store CAD data associated with one or more layers to be built to form the structure 12. The laser actuator 46 can include a processor or controller that can read the CAD data from the storage device and determine movement instructions for the laser device 44. The processor or controller of the laser actuator 46 can take the form of any processing or controlling device capable of providing the instructions to these devices, such as one or more microprocessors, one or more controllers, one or more digital signal processor (DSP), one or more application-specific integrated circuit (ASIC), one or more field-programmable gate array (FPGA), or other digital logic circuitry. The laser actuator 46 can include one or more motors or other mechanisms to move the laser device 44 into a specified orientation relative to the target area 16 in order to selectively aim the laser beam 42 onto a specified location in order to heat the polyimide precursor powder 14, e.g., to melt the powder 14 and initiate polymerization of the polyimide precursor compounds in order to form one or more polyimide layers of the structure 12.

The laser beam 42 can heat the powder particles of the precursor powder 14 at the target location 43 will melt and consolidate to form a reactive droplet of the polyimide precursor compounds in the precursor powder 14. The resulting temperature of the reactive droplet can be a polymerization temperature that allows for polymerization of the polyimide precursor compounds into a polyimide polymer at the target location 43. The reactive droplets can be further heated, either by the laser beam 42 or by another heating source, to a polymerization temperature. The polyimide precursor powder can include powder particles comprising at least one of one or more bisanhydride precursor compounds, one or more diamine precursor compounds, and a reaction product of one or more bisanhydride precursor compounds and one or more diamine precursor compounds that, when melted and heated to the polymerization temperature, will polymerize to form a polyimide, for example when heated to a temperature of at least about 250° C., such as at least about to about 300° C.

Polyimide materials have not typically been amendable to selective laser sintering because polyimides are amorphous, non-crystalline polymers that soften over a wide temperature range instead of liquefying at a set melting point. Moreover, polyimides tend to have large molecular weights such that, even if sufficiently melted, they would have a high viscosity that is not conducive to reflow, which is typically required for successful selective laser sintering. However, the system 10 described herein, as well as the other systems and methods described herein, uses a precursor powder 14 of a material having a molecular weight that is much lower than the final polyimide. The substantially lower molecular weight of the polyimide precursor compounds allows for lower viscosity and better reflow of the molten polyimide precursor. Fusion of adjacent powder particles can also occur at a significantly lower viscosity because the molecular weight of the polyimide polymer is built primarily after melting. The lower viscosity and better reflow of the melted polyimide precursor powder can allow for better adhesion between the adjacent particles and also between the melted polyimide precursor powder and a previously built polyimide layer, e.g., if the structure 12 comprises a plurality of polyimide layers. Good adhesion between adjacent melted powder particles and between adjacent layers can provide for less void space in the structure 12 and better overall mechanical strength of the structure 12. In addition to adhesion, the systems and methods described herein can have the capability of increasing the speed of the sintering process.

The polyimide precursor powder 14 can comprise a dry powder mixture of powder particles of one or more bisanhydride precursor compounds and powder particles of one or more diamine precursor compounds. The mixture of the bisanhydride particles and the diamine particles can be heated by application of the laser beam 42 so that the particles are raised above a melting temperature. The powder particles of the precursor compounds will melt and the molten precursor compounds can mix together to form a reactive mixture at the target locations 43. The laser beam 42 can heat the molten reactive mixture droplet to a polymerization reaction temperature, such as at least about 250° C., for example at least about to about 300° C., so that the bisanhydride precursor compounds and the diamine precursor compounds can react and polymerize to form a polyimide polymer.

The system 10 can include an environmental system to control one or more conditions to which the build area 18 is exposed. The environmental system can facilitate polymerization of the polyimide precursor compounds. The environmental system can control at least one of a selected temperature and a selected pressure. The environmental system can include a heater 48 for controlling the temperature. The heater 48 can preheat the build chamber 16 to a holding temperature, e.g., a temperature that is below the melting and polymerization temperature of the polyimide precursor powder 14. By heating the precursor powder 14 to a holding temperature, the laser system 40 can potentially be operated using less energy than when the precursor powder 14 is not heated to the holding temperature. For polymerization of one or more bisanhydride and one or more diamine precursor compounds, or a reaction product thereof, for example, the heater 48 can be configured to heat the build chamber 16 to a holding temperature of from about 100° C. to about 200° C. The heater 48 can be configured to further heat the formed structure 12 including polyimide after application of the laser beam 42 in order to further polymerization of the polyimide polymer in the structure 12. The laser beam 42 can be configured to melt the polyimide precursor powder 14 and heat it to a first temperature that may be less than the polyimide polymerization temperature, and then the heater 48 can increase the temperature of the melted polyimide precursor powder 14 to the polyimide polymerization temperature to complete polymerization of the layer being built. The heater 48 can heat the full structure 12 after all application of the laser beam 42 is complete to complete polymerization of the entire part 12. A secondary heating system, separate from the environmental system and the heater 48 can be included to provide supplemental heating. Supplemental heating by the secondary heating system can provide for further polymerization of the polyimide polymer in the structure 12, e.g., to complete polymerization of the structure 12 after the selective laser sintering has formed the part 12 from the polyimide precursor powder. The environmental system can include a pressure control system 50 for controlling a pressure within the build chamber 16. The pressure in the build chamber 16 can be controlled so that the pressure experienced by the precursor powder 14 and the molten polyimide precursor can be optimized for polymerization of the polyimide precursors.

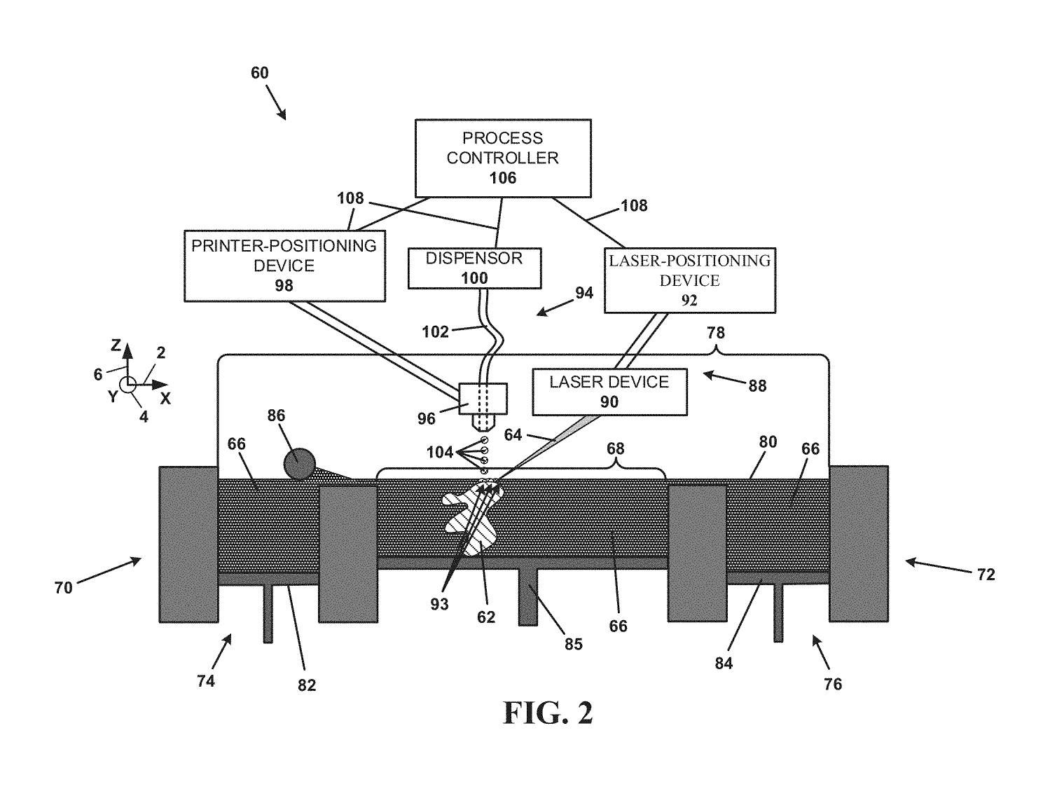

FIG. 2 is a conceptual diagram of another example selective laser sintering (SLS) system 60 for fabricating a structure 62 including polyimide by selectively aiming a focused energy beam 64, such as a laser beam 64, at a reactive polyimide precursor powder 66. The precursor powder 66 can be substantially identical to the precursor powder 14 described above with respect to FIG. 1. The precursor powder 66 can be fed to a target area 68, also referred to as a build area 68, by one or more powder feed systems 70, 72. Powder feed system 70, 72 can be substantially identical to the powder feed systems 20, 22 described above with respect to FIG. 1, e.g., with one or more powder cartridges 74, 76 and one or more powder moving mechanisms to move the precursor powder 66 from the powder cartridges 74, 76 to the target area 68. The powder cartridges 74, 76 and the target area 68 can, in combination, form a powder bed 78 with an upper powder surface 80, with the target area 68 forming a portion of the powder bed 78. The powder moving mechanisms can include one or more pistons 82, 84 to push the precursor powder 66 upward toward the powder bed 68 and one or more powder rollers 86 to push the precursor powder 66 onto the target area 68.

The laser beam 64 can be provided by a laser system 88. The laser system 88 can be substantially identical to the laser system 40 described above. The laser system 77 can include a laser device 90 that emits the laser beam 64. The laser beam 64 can be aimed by a laser actuator 92. The laser system 88 in the system 60 of FIG. 2 can be used in a similar manner to the laser system 40 described above with respect to FIG. 1. The laser system 88 can selectively aim the laser beam 64 onto a plurality of target locations 93 in order to selectively melt the polyimide precursor powder 66 and initiate polymerization of the polyimide precursor compounds therein at the target locations 93.

The system 60 can include a secondary feed system 94 to selectively deliver one or more liquid or solution-based compositions to the target area 68. The secondary feed system 94 can selectively deliver the liquid or solution-based composition to the same target locations 93 onto which the laser beam 64 is selective aimed. The liquid or solution-based compositions can cooperate with the laser beam 64 to initiate or propagate polymerization of the polyimide precursor compounds, e.g., at least one of one or more bisanhydride precursor compounds, one or more diamine precursor compounds, and a reaction product of one or more bisanhydride precursor compounds and one or more diamine precursor compounds, to form one or more polyimide layers, forming the structure 62.

The liquid or solution-based composition can effect a transformation of the precursor powder 66. The transformation effected by the liquid or solution-based composition can be beyond that which can be achieved by the laser beam 64 alone. The liquid or solution-based composition dispensed by the secondary feed system 94 can comprise a catalyst to the polymerization reaction of the polyimide precursor compounds in the precursor powder 66. The catalyst can allow for polymerization of the polyimide precursor compounds at a lower temperature. The catalyst can provide for a faster polymerization rate of the polyimide precursor compounds. The catalyst can reduce the energy requirement for the laser beam 64 and can, therefore, provide for a more energy-efficient system 60. The catalyst can be a liquid catalyst. The catalyst can be a solid that is dissolvable in a solvent to form a catalyst solution. The catalyst can be a slurry of small solid particles suspended in a suspension liquid, such as water or an alcohol. Examples of catalysts that can be used for polymerization of the polyimide precursor include, but are not limited to, secondary aliphatic amines, tertiary aliphatic amines such as triethylamine, aromatic amines such as quinolone, sodium phenylphosphinate, guanidinium salts, pyridinium salts, imidazolium salts, tetra(C₆₋₂₄)aryl ammonium salts, tetra(C₇₋₂₄ arylalkylene) ammonium salts, dialkyl heterocycloaliphatic ammonium salts, bis-alkyl quaternary ammonium salts, (C₇₋₂₄ arylalkylene)(C₁₋₁₆ alkyl) phosphonium salts, (C₆₋₂₄ aryl) (C₁₋₁₆ alkyl) phosphonium salts, phosphazenium salts, salts of carboxylic acids, and combinations thereof. In some examples, the catalyst can be dissolvable in the same solvent that forms a polyimide precursor solution (e.g., if the catalyst is being printed along with one of the polyimide precursor compounds in a solution, described below). In some examples, the catalyst can be dissolved in other common organic solvents such as acetone, ethyl acetate, hexane, cyclopentanone, cyclohexanone, and the like and added to the polyimide precursor solution.

The polyimide precursor powder 66 can comprise one or more first reactive polyimide precursor compounds and the liquid or solution-based composition dispensed by the secondary feed system 94 can comprises one or more second reactive polyimide precursor compounds. The second reactive polyimide precursor compounds in the liquid or solution-based composition can, upon application of the laser beam 64, react with the first reactive polyimide precursor of the precursor powder 66 to polymerize into the polyimide that forms the structure 62. For example, the polyimide precursor powder 66 can comprise one or more bisanhdyride precursor compounds and the liquid or solution-based composition can include a solution of one or more diamine precursor compounds in a solvent. The precursor powder 66 can comprise powder particles of one or more diamine precursor compounds and the liquid or solution-based composition can include a solution of one or more bisanhydride precursor compounds in a solvent. The solvent of the liquid or solution-based composition comprises water, an aliphatic alcohol, or a mixture of water and an aliphatic alcohol.

The liquid or solution-based composition dispensed by the secondary feed system 94 can comprise a mixture of both a catalyst and one or more reactive polyimide precursor compounds, e.g., a first of the bisanhydride precursor compounds and the diamine precursor compounds, while the precursor powder 66 can include a corresponding one or more reactive polyimide precursor compounds, e.g., a second of the bisanhydride precursor compounds and the diamine precursor compounds.

The liquid or solution-based composition dispensed by the secondary feed system 94 can comprise a solvent to at least partially dissolve at least a selected portion of the polyimide precursor compounds of the precursor powder 66 at the target locations 93. The laser beam 64 can be directed to the same target locations 93 where the solvent is printed to provide for polymerization of the at least partially dissolved one or more polyimide precursor compounds from the polyimide precursor powder 66.

The secondary feed system 94 can comprise a printing system 94 to print the liquid or solution-based composition onto the target area 68. The printing system 94 can include a printing device 96 that can print the liquid or solution-based composition onto the target area 68. Examples of printing devices 96 include, but are not limited to, an ink-jet printing device, a micro-jet printing device, a laser printing device, a screen printing device, a rotogravure printing device, or a transfer printing device. In the example shown in FIG. 2, the printing device 96 comprises a print head 96, such as an inkjet print head or a micro-jet print head.

The printing device 96 can be moved relative to the build area 68 so that the printing device 96 can be aimed onto one or more target locations 93 on the upper powder surface 80. The printing device 96 can be aimed toward a target location 93. The printing device 96 can be movable according to a specified coordinate system, such as Cartesian and polar coordinate systems. The specified coordinate system can be the same coordinate system that is used to control the laser system 88. The printing device 96 can be controlled to any position in an X-direction 2 (shown as being from left to right in FIG. 2). The printing device 96 can be moved to any position in a Y-direction 4 (shown as being into and out of the page in FIG. 2). The X-direction 2 can be substantially orthogonal to the Y-direction 4. Both the X- and Y-directions 2, 4 can be substantially parallel to the upper powder surface 80. The printing device 96 can be movable by a printer actuator 98 along the X-direction 2 and the Y-direction 4 over the build area 68. The printer positioning device 98 can include one or more motors and screw drives. The printer actuator 98 can move the printing device 96 in a Z-direction 6 (shown as being up and down in FIG. 2). The Z-direction 6 can be substantially orthogonal to one or more of the X-direction 2, the Y-direction 4, and the upper powder surface 80.

The printing devices 96 can be fed by one or more dispensers 100 for dispensing the liquid or solution-based composition to the corresponding printing device 96. The dispensers 100 can include one or more reservoirs for the liquid or solution being dispensed to the printing device 96. The dispensers 100 can include a pump or other fluid transfer device for moving the fluid from the reservoir to the printing device 96. The liquid or solution-based composition dispensed to the printing device 96 can be fed through a flexible conduit 102, such as one or more of flexible tubing and flexible piping, to accommodate movement of the printing device 96.

Like the system 10 of FIG. 1, the system 60 of FIG. 2 can include an environmental system to control the conditions to which the precursor powder 66, the liquid or solution-based composition, and the resulting structure 62 including polyimide are exposed. The environmental system can facilitate polymerization of the polyimide precursor compounds of the precursor powder 66 or the liquid or solution-based composition printed by the printed device 96 or both. The environmental system can control at least one of a selected temperature and a selected pressure. The environmental system can include a heater for controlling the temperature of the build area 68. The heater can heat a build chamber similar to the heater 48 heating the build chamber 16 in FIG. 1. The heater can preheat the build area 68 to a holding temperature, which can be less than a melting temperature of the precursor powder 66. The holding temperature can be less than a polymerization temperature of the polyimide precursor compounds. In some examples where the printed droplets 104 include a catalyst for polymerization of one or more bisanhydride precursor compounds and one or more diamine precursor compounds, the heater can be configured to heat the build area 68 to a holding temperature of from about 100° C. to about 200° C.

Dispensing a catalyst onto the precursor powder 66 can allow the heater to heat the build area 68 to a temperature. Dispensing a catalyst onto the precursor powder 66 can improve the rate of polymerization of the polyimide precursor compounds, improving cycle time. The catalyst can allow the laser system 88 to be operated using less energy. The heater can be configured to further heat the formed structure 62 including polyimide after application of the laser beam 64 to form the structure 62 including polyimide. The heater can be configured to heat the build area to a temperature sufficient to complete polymerization of the structure 62. The environmental system can include a pressure control system for controlling a pressure at the build area 68, e.g., a pressure controller to control a pressure within a build chamber. The pressure control system can be similar to the pressure control system 50 to control the pressure in the build chamber 16 in FIG. 1.

The system 60 can include a control system to control one or more components of the system 60. The control system can control one or more of the powder feed system, the laser system 88, and the secondary feed system 94. The control system can include one or more process controllers 106 that can process and provide instructions to the components being controlled. The process controller 106 can take the form of any processing or controlling device capable of providing the instructions to the components, such as one or more microprocessors, one or more controllers, one or more digital signal processor (DSP), one or more application-specific integrated circuit (ASIC), one or more field-programmable gate array (FPGA), and other digital logic circuitry. The instructions provided by the process controller 106 can take the form of electrical signals via one or more communication links 108. The communication links 108 can be any wired or wireless connection that can transmit signals between the process controller 106 and the device or devices received the signals. The process controllers 106 can be configured to control the environmental system, for example to control the temperature or the pressure, e.g., in order to control the reaction conditions to facilitate polymerization of the polyimide precursor compounds.

### Polyimide Reactive Stereolithography System

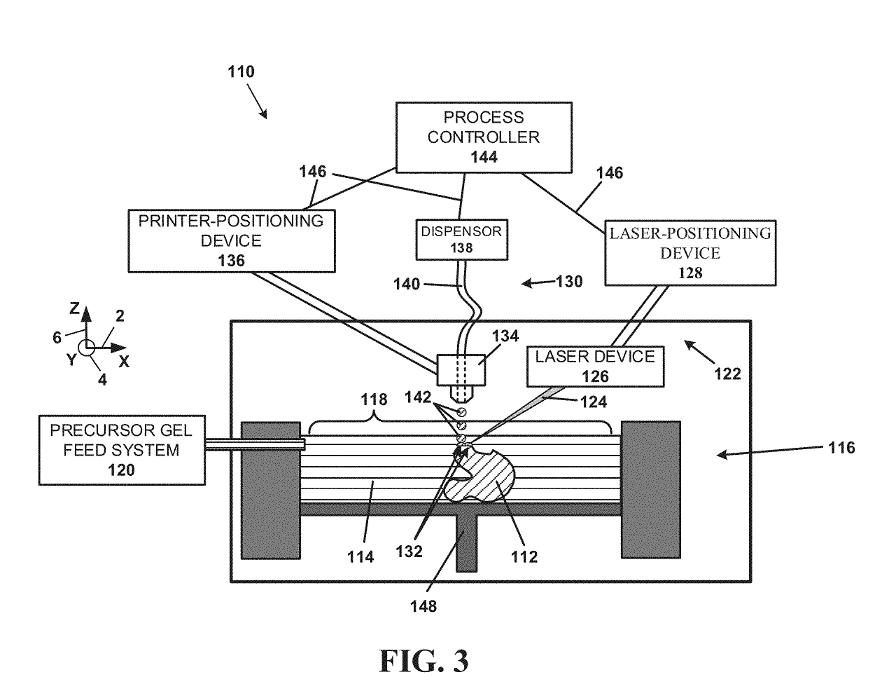

FIG. 3 shows an example stereolithography system 110 for fabricating a structure 112 including polyimide from a reactive polyimide precursor gel 114. The system 110 can include a build chamber 116 enclosing a target area 118, also referred to as a build area 118, where the structure 112 is to be built. The precursor gel 114 can comprise a viscous solution of one or more polyimide precursor compounds. Upon application of a focused energy beam, such as a laser beam, the polyimide precursor compounds of the precursor gel 114 can react and polymerize to form a structure 112 including polyimide. The polyimide precursor gel 114 can comprise a solution of at least one of one or more bisanhydride precursor compounds, one or more diamine precursor compounds, and a reaction product of one or more bisanhydride precursor compounds and one or more diamine precursor compounds. The polyimide precursor gel 114 can comprise a solution of an oligomeric reaction product of one or more bisanhydride precursor compounds and one or more diamine precursor compounds, for example an imide oligomer. The precursor gel 114 can include a solution of at least one of one or more bisanhydride precursor compounds and one or more diamine precursor compounds.

The system 110 can include a precursor gel feed system 120 to feed the precursor gel 114 to the target area 118. The precursor gel feed system 120 can comprise a reservoir for holding the precursor gel 114. The precursor gel feed system 120 can include a pump or other displacement device to deliver the precursor gel 114 to the target area 118. The precursor feed system 120 can include a device to position or flatten the precursor gel 114 in the target area 118, similar to the powder roller 36, 86 for the powder 14, 64, described above.

The system 110 can include a system 122 that can emit a focused energy beam 124. For the sake of brevity, the system 122 will be referred to herein as a laser system 122 and the focused energy beam 124 will be referred to as a laser beam 124. The laser beam 124 can be any focusable laser with a power output configured for various factors, including the specified heating of the precursor gel, expected gel energy absorption, scan rate, and illumination area. The laser beam 124 can comprise an infrared beam. In some examples, the laser beam 124 can have a wavelength of about 10.6 μm. The laser beam 124 can have a power output of from about 3 Watts to about 30 Watts. The laser beam 124 can have a beam width of from about 0.25 mm to about 1 mm, such as about 0.5 mm. The laser system 122 can be substantially similar to the laser systems 40 and 88 described above with respect to FIGS. 1 and 2, but with the laser beam 124 is being selectively directed toward the precursor gel 114. The laser system 122 can include a laser device 126 that emits the laser beam 124. The laser device 126 can comprise a CO₂ or infrared device. The laser system 122 can include a laser actuator 128 that selectively positions and directs the laser device 126 at the polyimide precursor gel 114 within the target area 118.

The laser device 126 can be configured to heat the precursor gel 114 to drive off solvent of the gel solution. The heating by the laser beam 124 can initiate polymerization of the polyimide precursor compounds to form a polyimide. The polymerized polyimide polymer can form one or more layers of the structure 112 including polyimide. The laser device 126 can be configured to heat the precursor gel 14 to a polymerization reaction temperature for polymerization of the polyimide precursor compounds in the precursor gel 114. The polyimide precursor compounds of the polyimide precursor gel 114 can include at least one of: one or more bisanhydride precursor compounds, one or more diamine precursor compounds, and a reaction product of one or more bisanhydride precursor compounds and one or more diamine precursor compounds. The polyimide precursor compounds can polymerize to form a polyimide polymer when the precursor gel 114 is heated to a temperature at or above the polymerization temperature. The polymerization temperature can be at least about 250° C., such as at least about to about 300° C.

The system 110 can optionally include a secondary feed system 130 to selectively dispense one or more liquid or solution-based compositions onto the target area 118. The secondary feed system 130 can be substantially identical to the secondary feed system 94 described above with respect to FIG. 2, with the secondary feed system 130 dispensing the liquid or solution-based compositions onto the polyimide precursor gel 114. The secondary feed system 130 can be configured to deliver the liquid or solution-based composition to the same target locations 132 onto which the laser beam 124 is selectively aimed by the laser system 122. The liquid or solution-based compositions can cooperate with the laser beam 124 to initiate or propagate polymerization of the polyimide precursor of the polyimide precursor gel 114 to form one or more polyimide layers to form the structure 112.

The liquid or solution-based composition dispensed by the secondary feed system 130 can comprise at least one of a catalyst to the polymerization reaction of the polyimide precursor compounds or one of the reactive polyimide precursors. In this way, the liquid or solution-based composition can be similar or identical to those compositions described above for the printing system 94.

In some examples, the secondary feed system 130 can comprise a printing system 130 to print the liquid or solution-based composition onto the target area 118. The printing system 130 can comprise a printing device 134 to print the liquid or solution-based composition onto the target area 118. Examples of printing devices 134 include, but are not limited to, inkjet printing devices, micro jet printing devices, laser printing devices, screen printing devices, rotogravure printing devices, and transfer printing devices. In the example shown in FIG. 3, the printing device 134 comprises a print head 134, such as inkjet and micro-jet print heads.

The printing device 134 can be configured to be aimed onto one or more target locations 132 on the polyimide precursor gel 114. The printing device 134 can be movable according to a coordinate system, such as Cartesian and polar coordinate systems. The coordinate system can be the same coordinate system that is used to control the laser system 122. The printing device 134 can be controlled to any position in an X-direction 2 (shown as being from left to right in FIG. 3). The printing device 134 can be controlled to any position in a Y-direction 4 (shown as being into and out of the page in FIG. 3). The X-direction 2 can be substantially orthogonal to the Y-direction 4. Both the X- and Y-directions 2, 4 can be substantially parallel to an upper surface of the polyimide precursor gel 114.

The printing device 134 can be movable by a printer actuator 136 along one or both of the X-direction 2 and the Y-direction 4 to aim the printing device 134 at the target locations 132. The printer actuator 136 can move the printing device 134 in a Z-direction 6 (shown as being up and down in FIG. 3). The Z-direction 6 can be substantially orthogonal to one or more of the X-direction 2, the Y-direction 4, and the upper surface of the polyimide precursor gel 114. The printing system 130 can include a dispenser 138 to dispense the liquid or solution-based composition to the printing device 134. The liquid or solution-based composition can be fed through a flexible conduit 140, such as flexible tubing and piping, to accommodate movement of the printing device 134. The printing device 134 can selectively print one or more droplets 142 of the liquid or solution-based composition onto the target locations 132 that will also be exposed to the laser beam 124. The constituents of the liquid or solution-based composition can be selected to effect a transformation of the polyimide precursor gel 114 beyond that which can be achieved by the laser beam 124.

The system 110 of FIG. 3 can include an environmental system to control the conditions to which the build area 118 is exposed. The environmental system can control at least one of a selected temperature and a selected pressure. The environmental system can include a heater for controlling temperature. The heater can heat the build chamber similar to the heater 48 heating the build chamber 16 in FIG. 1. The heater can preheat the build area 118 to a holding temperature. The holding temperature can be selected so that the polyimide precursor gel 114 reaches a reaction temperature. The reaction temperature can be sufficient to drive off the solvent in the polyimide precursor gel 114 and polymerize the polyimide precursor compounds therein. The holding temperature can be from about 100° C. to about 200° C. The heater can be configured to heat the formed structure 112 including polyimide after selective application of the laser beam 124 to form one or more layers of the structure 112. The heater can heat the structure 112 for further polymerization of the polyimide polymer therein. The heater can heat the structure 112 to complete polymerization of the structure 112. The environmental system can include a pressure control system for controlling pressure. The pressure control system can include a pressure controller similar to the pressure control system 50 to control the pressure in the build chamber 16 in FIG. 1.

The system 110 can include a control system to control one or more components of the system 110. The control system can control one or more of the laser system 122 and the optional secondary feed system 130. The control system can include one or more process controllers 144 to provide instructions to the components being controlled. The process controllers 144 can be substantially as described above for the process controllers 106 described above with respect to FIG. 2. The instructions provided by the process controller 144 can take the form of electrical signals via one or more communication links 146. The communication links 146 can be any wired or wireless connection. The process controllers 144 can be configured to control the environmental system. The process controllers 144 can be configured to control at least one of a specified temperature or a specified pressure, or both, experienced by the polyimide precursor gel 114 and the printed droplets 142. The process controllers 144 can control the reaction conditions to facilitate polymerization of the polyimide precursor compounds.

### Reactive Polyimide Part Forming Method

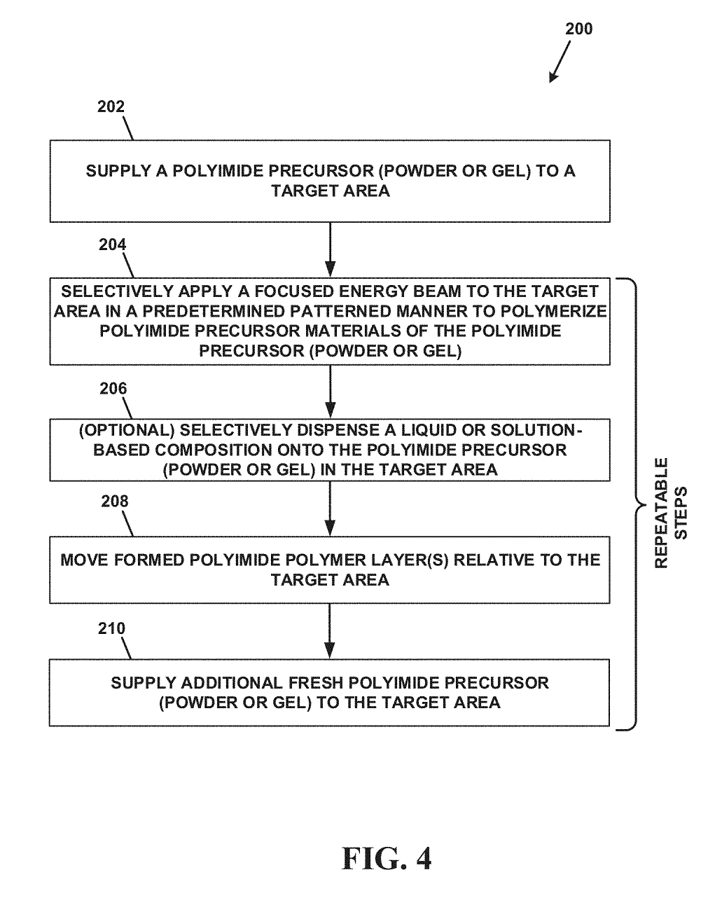

FIG. 4 is a flow diagram of an example method 200 of fabricating a structure including polyimide via selective application of a focused energy beam, such as a laser beam, to a polyimide precursor. In some examples, the polyimide precursor can comprise a polyimide precursor powder such that the method 200 can be a selective laser sintering (SLS) method. The application of the focused energy beam to the precursor powder can provide for melting and polymerization of one or more polyimide precursor compounds in the polyimide precursor powder into a polyimide polymer to form a structure including polyimide. In another example, the polyimide precursor can comprise a polyimide precursor gel such that the method 200 can be a stereolithography (SLA) method. The application of the focused energy beam to the precursor gel can provide for evaporation of the solvent of the gel and polymerization of one or more polyimide precursor compounds in the polyimide precursor gel into a polyimide polymer to form a structure. By way of example, the method 200 will be described with reference to systems 10 and 60 when referring to SLS of a powder precursor 14, 66, and to the system 110 when referring to SLA of a precursor gel 114. However, the description of the method with respect to specific structures shown in FIGS. 1-3 and described above is intended to be for illustrative purposes only, and is not meant to be limiting to the method 200.

The method 200 can include, at 202, supplying a polyimide precursor, e.g., a precursor powder 14 or a precursor gel 114, to a target area 18, 68, 118. The polyimide precursor 14, 66, 114 can comprise at least one of one or more bisanhydride precursor compounds, one or more diamine precursor compounds, and a reaction product of one or more bisanhydride precursor compounds and one or more diamine precursor compounds. The polyimide precursor 14, 66, 114 can be supplied by a precursor feed system, e.g., one or more powder feed systems 20, 22 or one or more precursor gel feed systems 120. At 204, a focused energy beam, such as a laser beam 42, 64, 124, can be selectively applied to the target area 18, 68, 118. The focused energy beam 42, 64, 124 can initiate polymerization of the polyimide precursor compounds present in the polyimide precursor 14, 66, 114 to form a polyimide polymer that will form the structure 12 including polyimide, 62, 112. The focused energy beam 42, 64, 124 can be applied in a pattern in order to polymerize the polyimide precursor compounds according to the pattern. The focused energy beam 42, 64, 124 can be aimed at one or more target locations 43, 93, 132. The target locations 43, 93, 132 can correspond to specific points, or pixels, of a section or layer of the structure 12 including polyimide, 62, 112 to be built. The target locations 43, 93, 132 can be identified and selected according to 3D CAD data. The 3D CAD data can be used to control the focused energy beam 42, 64, 124. The 3D CAD data can be used to drive a laser actuator 46, 92 to selective aim the laser device 44, 90, 126 to emit the laser beam 42, 64, 124 onto selected target locations 43, 93, 132. The 3D CAD data can include prepared CAD data corresponding to the location of material in a cross-section of the structure 12 including polyimide, 62, 112.

In examples where the polyimide precursor comprises a powder 14, 66 comprising one or more polyimide precursor compounds, application of the focused energy beam (step 204) can heat the precursor powder 14, 66 and cause the particles of the powder 14, 66 to melt and fuse together as reactive droplets. In examples where the polyimide precursor comprises a gel 114 made up of one or more polyimide precursor compounds in a solvent, the application of the focused energy beam 124 (step 204) can heat the precursor gel 114 at the target locations 132. Heating of the precursor gel 114 by the focused energy beam 124 can cause a solvent of the precursor gel 114 to evaporate. Heating the polyimide precursor 14, 66, 114 with the focused energy beam 42, 64, 124 can initiate polymerization of the polyimide precursor compounds to form the structure 112 including polyimide. The application of the focused energy beam 42, 64, 124 (step 204) can raise the temperature of the polyimide precursor 14, 66, 114 to a reaction temperature that initiates polymerization of the polyimide precursor compounds. The energy output of the focused energy beam 42, 64, 124 can be chosen to achieve a specified reaction temperature of the polyimide precursor compounds. The reaction temperature can be selected based on factors such as a specified level of polymerization of the polyimide polymer that forms the structure 12 including polyimide, 62, 112. For example, the reaction temperature (and thus the laser beam output energy) can be selected to achieve a specified final molecular weight for the polymerized precursor compounds. The temperature (and thus the output of the focused energy beam 42, 64) can be selected to achieve a specified polymerization rate. The focused energy beam 42, 64, 124 can be configured to heat the polyimide precursor 14, 66, 114 to a temperature sufficient for substantially complete polymerization of the precursor compounds. The focused energy beam 42, 64, 124 can heat the polyimide precursor 14, 66, 114 to a temperature that polymerizes the precursor compounds to a number average molecular weight of at least about 1,000 Daltons, such as at least about 5,000 Daltons, for example at least about 10,000 Daltons, such as at least about 50,000 Daltons, for example at least about 100,000, such as 150,000 Daltons or more. The focused energy beam 42, 64, 124 can be configured to heat the polyimide precursor 14, 66, 114 to polymerize the precursor compounds within a reasonable period of time, for example to a temperature of at least about 250° C., such as at least about to about 300° C. Higher temperatures, and thus higher focused energy beam energy outputs, will tend to result in higher molecular weight and faster polymerization.

The method 200 can optionally include, at 206, selectively dispensing a liquid or solution-based composition onto the polyimide precursor 14, 66, 114 in the target area 18, 68, 118. The liquid or solution-based composition can be selectively dispensed onto the same target locations 43, 93, 132 to which the focused energy beam 42, 64, 124 is applied. Dispensing the liquid or solution-based composition (step 206) can include printing the liquid or solution-based composition onto the target locations 43, 93, 132. A printing system 94, 130 can be used to print the liquid or solution-based composition. The printing system 94, 130 can include a printing device 96, 134, such as a print head 96, 134. Printing the liquid or solution-based composition (step 206) can comprise printing one or more droplets 104, 142 of the liquid or solution-based composition onto the polyimide precursor 14, 66, 114. The liquid or solution-based composition can comprise a catalyst composition to catalyze the polymerization of the polyimide precursor compounds of the polyimide precursor 14, 66, 114, e.g., one or more bisanhydride precursor compounds and one or more diamine precursor compounds, or the reaction product thereof. The polyimide precursor 14, 66, 114 can comprise a first one of the polyimide precursor compounds and the liquid or solution-based composition can comprise a second one of the polyimide precursor compounds. For example, the polyimide precursor 14, 66, 114 can comprise one or more bisanhydride precursor compounds and the liquid or solution-based composition can comprise one or more diamine precursor compounds, or vice versa. The liquid or solution-based composition can comprise both a catalyst and one or more polyimide precursor compounds.

After selectively applying the focused energy beam 42, 64, 124 (step 204) and optionally dispensing the liquid or solution-based composition (step 206), the method 200 can optionally include, at 208, moving the formed layer of the polyimide polymer material relative to the target area 18, 68, 118 to make room for another layer of the structure 12, 62, 112. For example, the built portion of the structure 12, 62, 112 can be moved downward relative to the target area 18, 68, 118 by lowering a piston 52, 85, 148 that supports the polyimide precursor 14, 66, 114 and the structure 12, 62, 112 in the build area 18, 68, 118. At 210, the method can optionally include supplying additional fresh polyimide precursor 14, 66, 114 to the target area 18, 68, 118. In the case of a precursor gel 114, the additional fresh polyimide precursor gel 114 can be added so that the formed portion of the structure 112 is submerged within the precursor gel 114. In some examples, supplying the polyimide precursor gel 114 to the target area 118 (step 202) can supply enough of the precursor gel 114 to supply the entire method 200, e.g., so that there is sufficient precursor gel 114 to build the entirety of the structure 112 submerged within the precursor gel 114. In such an example, the step (210) of supplying addition precursor gel 114 is not necessary, but can still optionally be performed.

Steps 204, 206 (optional), 208, and 210 can be repeated as many times as needed to build the structure 12 including polyimide, 62, 112 in a layer-by-layer manner in order to complete the structure 12, 62, 112, such as when a multi-layer structure 12, 62, 112 is being fabricated. For example, a first layer of the structure 12 including polyimide, 62, 112 can be formed by selectively application of the focused energy beam 42, 64, 124 onto target locations 43, 93, 132 in order to polymerize the polyimide precursor compounds of the polyimide precursor 14, 66, 114 (step 204). Optionally, a liquid or solution-based composition, such as a catalyst or a polyimide precursor solution, can be dispensed onto the same target locations 43, 93, 132 to which the focused energy beam 42, 64, 124 is applied (step 206). The liquid or solution-based composition can be dispensed onto the target locations 43, 93, 132 close in time to the performance of step 206, such as substantially simultaneous with step 206. The selective application of the focused energy beam 42, 64, 124, and optionally selective dispensing of the liquid or solution-based composition, can result in polymerization of the polyimide precursor compounds of the polyimide precursor 14, 66, 114, such as one or more bisanhydride precursor compounds and one or more diamine precursor compounds or a reaction product thereof, to form a polyimide polymer that can make up a first layer of the structure 12 including polyimide, 62, 112. Then, the formed first layer of the structure 12, 62, 112 can be moved relative to the target area 18, 68, 118 (step 208), e.g., moved downward, and, optionally, new polyimide precursor 14, 66, 114 can be supplied to the target area 18, 68, 118 (step 210).

Next, the focused energy beam 42, 64, 124 can be selectively applied to the target area 18, 68, 118 (step 204 repeated). Optionally, the liquid or solution-based composition can be selectively dispensed onto the target area 18, 68, 118 (optional step 206 repeated) to form a second layer of the structure 12 including polyimide, 62, 112. After the second layer is formed, the first and second layers can be moved downward relative to the target area 18, 68, 118 (step 208 repeated). Optionally, fresh polyimide precursor 14, 66, 114 can be added to the target area 18, 68, 118 (step 210 repeated). Successive layers can be built until the structure 12, 62, 112 is completed. For example, these steps can be repeated to form a third layer, a fourth layer, a fifth layer, a sixth layer, and so on until the structure 12, 62, 112 is fully formed. If a single-layer structure 12, 62, 112 is being fabricated, then steps 204, 206 (optionally), 208 (optionally), and 210 (optionally) need not be repeated to form the single-layer structure 12, 62, 112.

The polyimide precursor 14, 66, 114 can comprise at least one of one or more bisanhydride precursor compounds and one or more diamine precursor compounds. The bisanhydride precursor compounds can comprise one or more aromatic bisanhydride precursor compounds, such as one or more bisphenol bisanhydrides, for example bisphenol A bisanhydride. The diamine precursor compounds can comprise one or more aromatic diamine precursor compounds, such as metaphenylene diamine. In examples where the polyimide precursor is a gel 114, the precursor gel 114 can comprise these compounds in a solvent. The solvent of the gel 114 can comprise at least one of water and an aliphatic alcohol, such as at least one of methanol and ethanol. The gel 114 can further comprise a secondary or tertiary amine. The secondary or tertiary amine of the gel 114 can comprise at least one of dimethylethanolamine and trimethylamine.

### Materials for Reactive Polyimide Printing

The printing systems described above with respect to FIGS. 1-3 and the methods described above with respect to FIG. 4 can be performed using the following materials.

The printing systems and methods described herein provide for fabrication of a polyimide article using selective application of a focused energy beam. The systems and methods can include the use of one or more a polyimide precursors that can be solubilized with solvents other than harsh organic solvents. As described in more detail below, the polyimide material can be formed from a polyimide precursor solution. The polyimide precursor solution can comprise one or more bisanhydride precursor compounds and one or more diamine precursor compounds dissolved in a solvent, or a reaction product of the bisanhydride precursor compounds and the diamine precursor compounds. An amine can also be added to the precursor solution, which can allow for effective dissolution of the precursor compounds in mild solvents, such as a C₁₋₆ alcohol, a mixture of a C₁₋₆ alcohol and water, or in water. Polyimides formed from the polyimide precursor solution can be formed in the absence of a chain-stopping agent, allowing high molecular weight polyimides to be obtained. Other components, such as crosslinkers and particulate fillers, can be used.

The polyimide precursor solution can be used to form a precursor powder for use in the selective laser sintering systems and methods described above. For example, solvent can be removed from the precursor solution to form particles of the polyimide precursor. The polyimide precursor compounds of the polyimide precursor solution (e.g., the bisanhydride precursor compounds and the diamine precursor compounds) can partially reaction in the solution to form an oligomeric reaction product, e.g., an oligomeric imide or a partially polymerized (e.g., B-stage) polyimide. As described above, a precursor powder can also be made from powder particles of one or more precursor compounds, e.g., first powder particles of one or more bisanhydride precursor compounds and second powder particles of one or more diamine precursor compounds.

The polyimide precursor solution can also form or be used to form a polyimide precursor gel for use in the stereolithograpy systems and methods described above.

Bisanhydride Precursor Compound

The bisanhydride precursor compounds can be a substituted or unsubstituted C₄₋₄₀ bisanhydride. In some examples, the bisanhydride precursor compounds can have the formula (1)

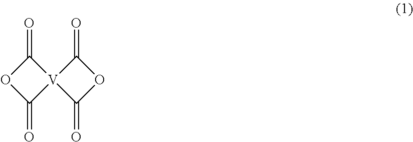

wherein V is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted C₄₋₈ cycloalkylene group or a halogenated derivative thereof, in particular a substituted or unsubstituted C₆₋₂₀ aromatic hydrocarbon group. Exemplary aromatic hydrocarbon groups include, but are not limited to, any of those of the formulas

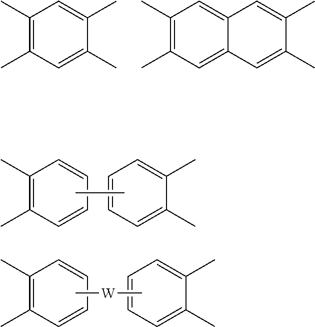

wherein W is —O—, —S—, —C(O)—, —SO₂—, —SO—, —C_{y}H_{2y}—, wherein y is an integer from 1 to 5 or a halogenated derivative thereof (which includes perfluoroalkylene groups), or a group of the formula T as described in formula (2) below.

The polyimides can include polyetherimides. Polyetherimides are prepared by the reaction of an aromatic bis(ether anhydride) of formula (2)

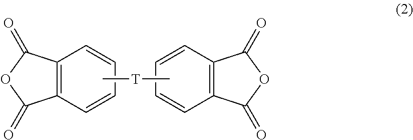

wherein T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (2) can also be a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3)

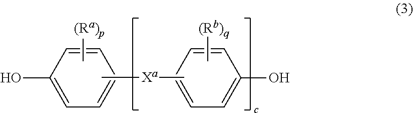

wherein R^{a} and R^{b} can be the same or different and are a halogen atom or a monovalent C₁₋₆ alkyl group, for example; p and q are independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X′ can be a single bond, —O—, —S—, —S(O)—, —SO₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

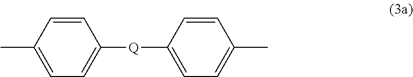

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is derived from bisphenol A, such that Q in formula (3a) is 2,2-isopropylidene.

Examples of bis(anhydride)s include, but are not limited to, 3,3-bis[4-(3,4-dicarboxyphenoxy)phenyl]propane bisanhydride; 4,4′-bis(3,4-dicarboxyphenoxy)diphenyl ether bisanhydride; 4,4′-bis(3,4-dicarboxyphenoxy)diphenyl sulfide bisanhydride; 4,4′-bis(3,4-dicarboxyphenoxy)benzophenone bisanhydride; 4,4′-bis(3,4-dicarboxyphenoxy)diphenyl sulfone bisanhydride; 2,2-bis[4-(2,3-dicarboxyphenoxy)phenyl]propane bisanhydride; 4,4′-bis(2,3-dicarboxyphenoxy)diphenyl ether bisanhydride; 4,4′-bis(2,3-dicarboxyphenoxy)diphenyl sulfide bisanhydride; 4,4′-bis(2,3-dicarboxyphenoxy)benzophenone bisanhydride; 4,4′-bis(2,3-dicarboxyphenoxy)diphenyl sulfone bisanhydride; 4-(2,3-dicarboxyphenoxy)-4′-(3,4-dicarboxyphenoxy)diphenyl-2,2-propane bisanhydride; 4-(2,3-dicarboxyphenoxy)-4′-(3,4-dicarboxyphenoxy)diphenyl ether bisanhydride; 4-(2,3-dicarboxyphenoxy)-4′-(3,4-dicarboxyphenoxy)diphenyl sulfide bisanhydride; 4-(2,3-dicarboxyphenoxy)-4′-(3,4-dicarboxyphenoxy)benzophenone bisanhydride; and, 4-(2,3-dicarboxyphenoxy)-4′-(3,4-dicarboxyphenoxy)diphenyl sulfone bisanhydride, and combinations thereof.

The bisanhydride precursor compounds can be in particulate (e.g., powder) form. A bisanhydride monomer powder can have D100 of 100 μm or less, 75 μm or less, or 45 μm or less. As used herein “D100” means that 100% of the particles have a size distribution less than or equal to the named value. In some examples, the particles have can have a particle size of 0.01 to 100 μm, 0.01 to 75 μm, or 0.01 to 45 μm. A bimodal, trimodal, or higher particle size distribution can be used. The precursor compounds can be present in the particulates separately (e.g., particles comprising the bisanhydride and particles comprising the diamine) or as a mixture (e.g., particles comprising a combination of the bisanhydride and the diamine) The precursor compounds can be reduced to the specified particle size by methods known in the art, for example grinding and sieving. Other milling techniques are known, for example jet milling, which subjects the particles to a pressurized stream of gas and particle size is reduced by interparticle collisions.

Diaamine Precursor Compound

In some examples, the diamine one or more have general formula (4)

H₂N—R—NH₂ (4)

wherein R is a substituted or unsubstituted divalent C₁₋₂₀ hydrocarbon group, e.g., a substituted or unsubstituted C₆₋₂₀ aromatic hydrocarbon group or a halogenated derivative thereof, a substituted or unsubstituted, straight or branched chain, saturated or unsaturated C₂₋₂₀ alkylene group or a halogenated derivative thereof, a substituted or unsubstituted C₃₋₈ cycloalkylene group or halogenated derivative thereof, in particular one of the divalent groups of formula (5)

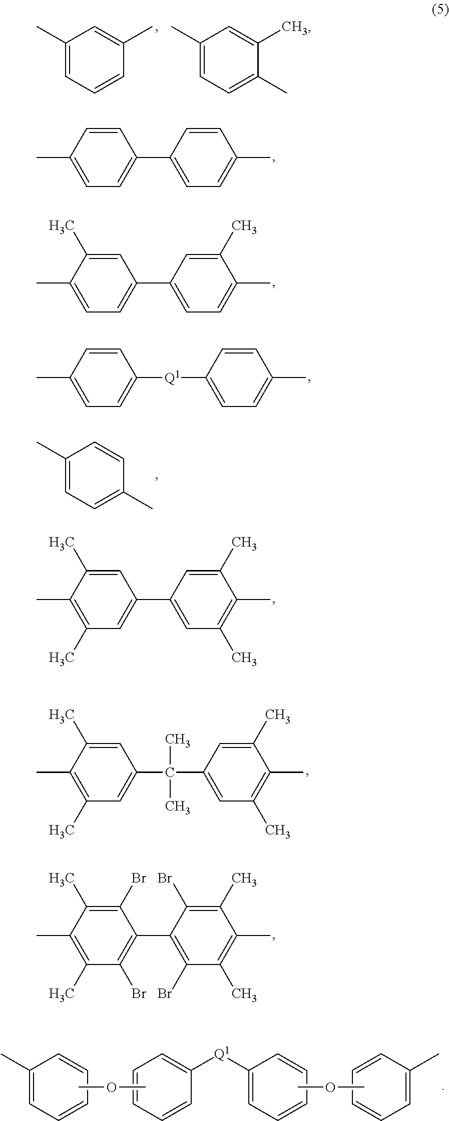

wherein Q¹ is —O—, —S—, —SO₂—, —SO—, —C_{y}H₂— wherein y is an integer from 1 to 5 or a halogenated derivative thereof (which includes perfluoroalkylene groups), or —(C₆H₁₀)_{z}— wherein z is an integer from 1 to 4. In some examples, R is m-phenylene, p-phenylene, or 4,4′-diphenylene sulfone. In some examples, no R groups contain sulfone groups. In another embodiment, at least 10 mol. % of the R groups contain sulfone groups, for example 10 to 80 wt. % of the R groups contain sulfone groups, in particular 4,4′-diphenylene sulfone groups.

Examples of organic diamines include, but are not limited to, ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, and bis(4-aminophenyl) ether. Combinations of these compounds can also be used. The organic diamine can comprise m-phenylenediamine, p-phenylenediamine, 4,4′-sulfonyl dianiline, or combinations thereof.

The aromatic bisanhydride precursor compounds of formula (1) or (2) can be reacted with one or more diamine precursor compounds comprising one or more organic diamines of formula (4) as described above or a mixture of diamines, and a polysiloxane diamine of formula (6)

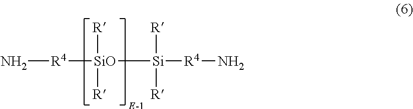

wherein each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In some examples, no halogens are present. Combinations of the foregoing R′ groups can be used in the same copolymer. In some examples, the polysiloxane diamine comprises R′ groups that have minimal hydrocarbon content, e.g., methyl groups.

E in formula (6) has an average value of 5 to 100, and each R⁴ is independently a C₂-C₂₀ hydrocarbon, in particular a C₂-C₂₀ arylene, alkylene, or arylenealkylene group. In some examples, R⁴ is a C₂-C₂₀ alkyl group, specifically a C₂-C₂₀ alkyl group such as propylene, and E has an average value of 5 to 100, 5 to 75, 5 to 60, 5 to 15, or 15 to 40. Procedures for making the polysiloxane diamines of formula (6) are well known in the art.

The diamine can contain 10 to 90 mole percent (mol %), or 20 to 50 mol %, or 25 to 40 mol % of polysiloxane diamine (5) and 10 to 90 mol %, or 50 to 80 mol %, or 60 to 75 mol % of diamine (4). The diamine can be physically mixed prior to reaction with the bisanhydride(s), thus forming a substantially random copolymer. Block or alternating copolymers can be formed by selective reaction of (4) and (6) with aromatic bis(ether anhydride)s (1) or (2), to make polyimide blocks that are subsequently reacted together. Thus, the polyimide-siloxane copolymer can be a block, random, or graft copolymer.

The diamine precursor compounds can be in particulate (e.g., powder) form. In some examples, the diamine precursor compound powder can have D100 of 100 μm or less, 75 μm or less, or 45 μm or less. As used herein “D100” means that 100% of the particles have a size distribution less than or equal to the named value. In some examples, the particles can have a particle size of 0.01 to 100 μm, 0.01 to 75 μm, or 0.01 to 45 μm. A bimodal, trimodal, or higher particle size distribution can be used. The precursor compounds can be present in the particulates separately (e.g., particles comprising the bisanhydride and particles comprising the diamine) or as a mixture (e.g., particles comprising a combination of the bisanhydride and the diamine) The precursor compounds can be reduced to the specified particle size by methods known in the art, for example grinding and sieving. Other milling techniques are known, for example jet milling, which subjects the particles to a pressurized stream of gas and particle size is reduced by interparticle collisions.

The relative ratios of the bisanhydride and the diamine (either the relative ratio of the precursor compound powders, or the relative ratio of the precursor compounds used to make a prepolymer powder) can be varied depending on specified properties of the polyimides. Use of an excess of either precursor compound can result in a polymer having functionalized end groups. For example, a mole ratio of the bisanhydride to the diamine can be 1.3:1 to 1:1.3, preferably 0.95:1 to 1:0.95. In some examples, a mole ratio of the bisanhydride to the diamine can be 1:1 to 1:1.3, preferably 1:1 to 1:1.2 or 1:1 to 1:1.1. In another embodiment, a mole ratio of the diamine to the bisanhydride is 1:1 to 1:1.3, preferably 1:1 to 1:1.2 or 1:1 to 1:1.1.

Polyimide Prepolymer

In some examples, a polyimide prepolymer can be a reaction product of the bisanhydride precursor compounds and the diamine one or more described above, such as a reaction product between a substituted or unsubstituted C₄₋₄₀ bisanhydride and a substituted or unsubstituted divalent C₁₋₂₀ diamine. The polyimide prepolymer can be put into a particulate form, e.g., to form a polyimide precursor powder, or can be used to form a polyimide precursor gel.

The polyimide precursor can be formed by reacting the bisanydride precursor compounds described above with the diamine precursor compounds described above. In some examples, the polyimide precursor comprises more than 1, for example 10 to 1000, or 10 to 500, structural units of formula (7)

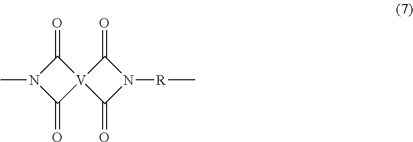

wherein each V is the same or different, and is as described in formula (1), and each R is the same or different, and is defined as in formula (4). The polyetherimides comprise more than 1, for example 10 to 1000, or 10 to 500, structural units of formula (8)

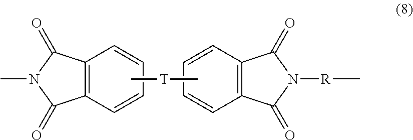

wherein each T is the same or different, and is as described in formula (2), and each R is the same or different, and is as described in formula (4), preferably m-phenylene or p-phenylene.

The polyetherimides can optionally further comprises up to 10 mole %, up to 5 mole %, or up to 2 mole % of units of formula (8) wherein T is a linker of the formula (9)

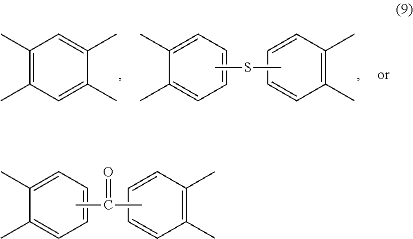

In some examples no units are present wherein R is of these formulas.

In some examples in formula (1), R is m-phenylene or p-phenylene and T is —O—Z—O— wherein Z is a divalent group of formula (3a). Alternatively, R can be m-phenylene or p-phenylene and T is —O—Z—O wherein Z is a divalent group of formula (3a) and Q is 2,2-isopropylidene.

In some examples, the polyetherimide can be a polyetherimide sulfone. For example, the polyetherimide can comprise the etherimide units wherein at least 10 mole percent, for example 10 to 90 mole percent, 10 to 80 mole percent, 20 to 70 mole percent, or 20 to 60 mole percent of the R groups comprise a sulfone group. For example, R can be 4,4′-diphenylene sulfone, and Z can be 4,4′-diphenylene isopropylidene, providing units of formula (10).

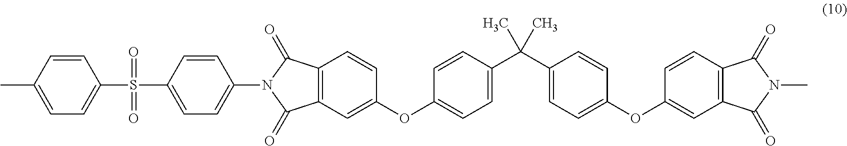

In another embodiment, the polyetherimide can be a polyetherimide-siloxane block or graft copolymer. Block polyimide-siloxane copolymers comprise imide units and siloxane blocks in the polymer backbone. Block polyetherimide-siloxane copolymers comprise etherimide units and siloxane blocks in the polymer backbone. The imide or etherimide units and the siloxane blocks can be present in random order, as blocks (i.e., AABB), alternating (i.e., ABAB), or a combination thereof. Graft copolymers are non-linear copolymers comprising the siloxane blocks connected to a linear or branched polymer backbone comprising imide or etherimide blocks.

In some examples, a polyetherimide-siloxane has units of the formula

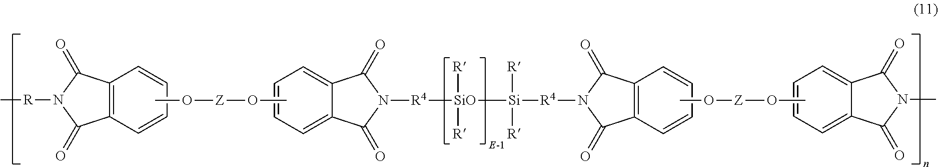

wherein R′, R⁴, and E of the siloxane are as in formula (6), R is as in formula (4), Z is as in formula (2), and n is an integer from 5 to 100. In a specific embodiment, the R of the etherimide is a phenylene, Z is a residue of bisphenol A, R⁴ is n-propylene, E is 2 to 50, 5, to 30, or 10 to 40, n is 5 to 100, and each R′ of the siloxane is methyl. In some examples the polyetherimide-siloxane comprises 10 to 50 weight %, 10 to 40 weight %, or 20 to 35 weight % polysiloxane units, based on the total weight of the polyetherimide-siloxane.

The polyimide prepolymer can comprise partially reacted units of formulas q and r to fully reacted units of formula s.

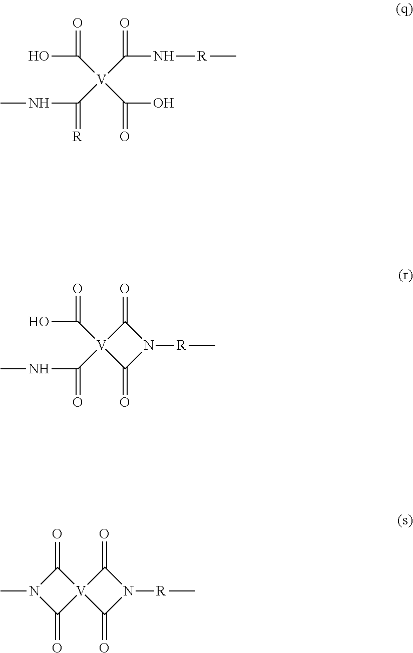

wherein V and R are as defined above. The polyimide prepolymer contains at least one unit (q), 0 or 1 or more units (r), and 0 or 1 or more units (s), for example 1 to 200 or 1 to 100 units q, 0 to 200 or 0 to 100 units (r), or 0 to 200 or 0 to 100 units (s). An imidization value for the polyimide prepolymer can be determined using the relationship

(2s+r)/(2q+2r+2s)

Wherein q, r, and s stand for the number of units (q), (r), and (s), respectively. In some examples, the imidization value of the polyimide prepolymer is less than or equal to 0.2, less than or equal to 0.15, or less than or equal to 0.1. In some examples, the polyimide prepolymer has an imidization value of greater than 0.2, for example greater than 0.25, greater than 0.3, or greater than 0.5, provided that the specified solubility of the polyimide prepolymer is maintained. The number of units if each type can be determined by spectroscopic methods, for example FT-IR.

Aqueous Carrier

The polyimide-forming solution can comprise an aqueous carrier for the particulate precursor composition. Small amounts of an organic solvent can be present, for example 0.1 to 5 wt. % of an organic solvent, wherein the organic solvent is a protic or nonprotic organic solvent. Possible protic organic solvents include C₁₋₆ alkyl alcohols wherein the alkyl group linear or branched. In some examples, the aliphatic alcohol is substantially miscible with water, e.g., is methanol, ethanol, propanol, or isopropanol.

In some examples, the aqueous carrier comprises water, for example deionized water, and less than 10 wt. % of an organic solvent, preferably less than 1 wt. %, most preferably no organic solvent. In another embodiment the aqueous carrier comprises less than 1 wt. %, and is preferably devoid of a halogenated organic solvent. Still further, the aqueous carrier can comprise less than 1 wt. %, or be devoid of, a chlorobenzene, a dichlorobenzene, cresol, dimethyl acetamide, veratrole, pyridine, nitrobenzene, methyl benzoate, benzonitrile, acetophenone, n-butyl acetate, 2-ethoxyethanol, 2-n-butoxyethanol, dimethyl sulfoxide, anisole, cyclopentanone, gamma-butyrolactone, N,N-dimethyl formamide, N-methyl pyrrolidone, or a combination comprising at least one of the foregoing.

Surfactant

The polyimide-forming composition can further comprise a surfactant. The surfactant can maintains the particulate precursor composition as a suspension in the aqueous carrier. The surfactant can be cationic, anionic, amphoteric, or nonionic.

Preferably, the surfactant is nonionic. Among the nonionic surfactants that can be used are fatty acid amides, in particular those of the formula wherein R is C₇₋₂₁ alkyl or alkenyl group each R¹ is independently hydrogen, C₁₋₄ alkyl, C₁₋₄ hydroxyalkyl, or —(C₂H₄O)ₓH wherein x is 1 to 15. Specific fatty acid amides are those wherein R is C₈₋₁₈ alkyl or alkenyl, one R¹ is hydrogen and the other R¹ is a group of formula —(C₂H₄O)ₓH wherein x is 2 to 10.

Other nonionic surfactants include C₈₋₂₂ aliphatic alcohol ethoxylates having about 1 to about 25 mol of ethylene oxide and having have a narrow homolog distribution of the ethylene oxide (“narrow range ethoxylates”) or a broad homolog distribution of the ethylene oxide (“broad range ethoxylates”); and preferably C₁₀₋₂₀ aliphatic alcohol ethoxylates having about 2 to about 18 mol of ethylene oxide. Examples of commercially available nonionic surfactants of this type are Tergitol™ 15-S-9 (a condensation product of C₁₁₋₁₅ linear secondary alcohol with 9 moles ethylene oxide), Tergitol™ 24-L-NMW (a condensation product of C₁₂₋₁₄ linear primary alcohol with 6 moles of ethylene oxide) with a narrow molecular weight distribution from Dow Chemical Company. This class of product also includes the Genapol™ brands of Clariant GmbH.

Other nonionic surfactants that can be used include polyethylene, polypropylene and polybutylene oxide condensates of C₆₋₁₂ alkyl phenols, for example compounds having 4 to 25 moles of ethylene oxide per mole of C₆₋₁₂ alkylphenol, preferably 5 to 18 moles of ethylene oxide per mole of C₆₋₁₃ alkylphenol. Commercially available surfactants of this type include Igepal® CO-630, Triton® X-45, X-114, X-100 and X102, Tergitol™ TMN-10, Tergitol® TMN-100X, and Tergitol™ TMN-6 (all polyethoxylated 2,6,8-trimethyl-nonylphenols or mixtures thereof) from Dow Chemical Corporation, and the Arkopal-N products from Hoechst AG.

Stilt others include the addition products of ethylene oxide with a hydrophobic base formed by the condensation of propylene oxide with propylene glycol. The hydrophobic portion of these compounds preferably has a molecular weight between about 1500 and about 1800 Daltons. Commercially available examples of this class of product are the Pluronic® brands from BASF and the Genapol® PF trademarks of Hoechst AG.

The addition products of ethylene oxide with a reaction product of propylene oxide and ethylenediamine can also be used. The hydrophobic moiety of these compounds consists of the reaction product of ethylenediamine and excess propylene oxide, and generally has a molecular weight of about 2500 to about 3000 Daltons. This hydrophobic moiety of ethylene oxide is added until the product contain from about 40 to about 80 wt. % of polyoxyethylene and has a molecular weight of about 5000 to about 11,000 Daltons. Commercially available examples of this compound class are the Tetronic® brands from BASF and the ® Genapol PN trademarks of Hoechst AG.

Anionic surfactants include the alkali metal, alkaline earth metal, ammonium and amine salts, of organic sulfuric reaction products having in their molecular structure a C8-36, or C8-22, alkyl group and a sulfonic acid or sulfuric acid ester group. Included in the term alkyl is the alkyl portion of acyl radicals. Examples of are the sodium, ammonium, potassium or magnesium alkyl sulfates, especially those obtained by sulfating the higher alcohols (C₈₋₁₈ carbon atoms) sodium or magnesium alkyl benzene or alkyl toluene sulfonates, in which the alkyl group contains from about 9 to about 15 carbon atoms, the alkyl radical being either a straight or branched aliphatic chain; sodium or magnesium paraffin sulfonates and olefin sulfonates in which the alkyl or alkenyl group contains 10 to about 20 carbon atoms; sodium C₁₀₋₂₀ alkyl glyceryl ether sulfonates, especially those ethers of alcohols derived from tallow and coconut oil; sodium coconut oil fatty acid monoglyceride sulfates and sulfonates; sodium, ammonium or magnesium salts of (C₈₋₁₂alkyl) phenol ethylene oxide ether sulfates with about 1 to about 30 units of ethylene oxide per molecule; the reaction products of fatty acids esterified with isethionic acid and neutralized with sodium hydroxide where, for example, the fatty acids are derived from coconut sodium or potassium salts of fatty acid amides of a methyl tauride in which the fatty acids, for example, are derived from coconut oil and sodium or potassium beta-acetoxy or beta-acetamido-alkanesulfonates where the alkane has from 8 to 22 carbon atoms.

Among the specific anionic surfactants that can be used are C₈₋₂₂ alkyl sulfates (e.g., ammonium lauryl sulfate, sodium lauryl sulfate, sodium lauryl ether sulfate (SLES), sodium myreth sulfate, and dioctyl sodium sulfosuccinate), C₈₋₃₆ alkyl sulfonates comprising an organic sulfonate anion (e.g., octyl sulfonate, lauryl sulfonate, myristyl sulfonate, hexadecyl sulfonate, 2-ethylhexyl sulfonate, docosyl sulfonate, tetracosyl sulfonate, p-tosylate, butylphenyl sulfonate, dodecylphenyl sulfonate, octadecylphenyl sulfonate, and dibutylphenyl, sulfonate, diisopropyl naphthyl sulfonate, and dibutylnaphthyl sulfonate) and a cation (e.g., phosphonium or ammonium), C₈₋₃₆ perfluoroalkylsulfonates (e.g., perfluorooctanesulfonate (PFOS), perfluorobutanesulfonate), and linear C₇₋₃₆ alkylbenzene sulfonates (LABS) (e.g., sodium dodecylbenzenesulfonate). Alkyl ether sulfates having the formula RO(C₂H₄O)ₓSO₃M wherein R is a C₈₋₃₆ alkyl or alkenyl, x is 1 to 30, and M is a water-soluble cation. The alkyl ether sulfates are condensation products of ethylene oxide and monohydric alcohols having from about 10 to about 20 carbon atoms. Preferably, R has 10 to 16 carbon atoms. The alcohols can be derived from natural fats, e.g., coconut oil or tallow, or can be synthetic. Such alcohols are reacted with 1 to 30, and especially 1 to 12, molar proportions of ethylene oxide and the resulting mixture of molecular species is sulfated and neutralized.

Among the cationic surfactants that can be used are of quaternary phosphonium or ammonium type, having one, two, or more chains which contain an average of from 12 to 22, preferably from 16 to 22, more preferably from 16 to 18, carbon atoms. The remaining groups, if any, attached to the quaternary atom are preferably C₁ to C₄ alkyl or hydroxyalkyl groups. Although it is preferred that the long chains be alkyl groups, these chains can contain hydroxy groups or can contain heteroatoms or other linkages, such as double or triple carbon-carbon bonds, and ester, amide, or ether linkages, as long as each chain falls within the above carbon atom ranges. Examples include cetyltriethylammonium chloride, diethylmethyl-(2-oleoamidoethyl)ammonium methyl sulfate, cetyl trimethylammonium bromide, dimethyl distearyl ammonium chloride, octadecyltrimethylammonium chloride, stearamidopropyldimethyl-fi-hydroxyethylammonium nitrate, stearamidopropyldimethyl-B-hydroxyethylammonium dihydrogen phosphate, N,N-dimethyl-N-benzyl-N-octadecyl ammonium chloride, N,N-dimethyl-N-hydroxyethyl-N-dodecyl ammonium chloride, N,N-dimethyl-N-benzyl-N-octadecenyl ammonium chloride, N,N-dimethyl-N-benzyl-N-dodecyl ammonium chloride, N,N-dimethyl-N-hydroxyethyl-N-benzyl ammonium chloride, hexadecylpyridinium chloride, hexadecyltriethylammonium bromide, octadecylbenzyl trimethylammonium methosulfate, isopropylnaphthyltrimethylammonium chloride, octadecyl pyridinium bromide, I—(Z-hydroxyethyl)-2-heptadecenyl-1-(4-chlorobutyl) imidazolinium chloride, hexadecylmethylpiperidinium methosulfate, dodecylhydroxyethylmorpholinium bromide, and N-cetyl-N-ethyl morpholinium ethosulfate.

The polyimide-forming compositions can comprise, based on the total weight of the compositions, 1 to 90 weight percent (wt. %), preferably 5 to 75 wt. %, more preferably 10 to 30 wt. % of the particulate polyetherimide precursor composition; 10 to 99 wt. %, preferably 25 to 95 wt. %, more preferably 70 to 90 wt. % of the aqueous carrier, and 0.001 to 10 wt. %, preferably 0.05 to 5 wt. %, more preferably 0.1 to 2.5 wt. % of the surfactant.

Amine

The polyimide precursor solution can further include an amine. The amine can comprise a secondary amine, a tertiary amine, or a combination comprising at least one of the foregoing. In some examples, the amine preferably comprises a tertiary amine.

The amine can be selected such that less than or equal to 0.5 grams of the amine is effective to solubilize 1 gram of the polyimide prepolymer in deionized water.

In some examples, the amine is a secondary or a tertiary amine of the formula (12)

R^{A}R^{B}R^{C}N (12)

wherein each R^{A}, R^{B}, and R^{C} can be the same or different and are a substituted or unsubstituted C₁₋₁₈ hydrocarbyl or hydrogen, provided that no more than one of R^{A}, R^{B}, and R^{C} are hydrogen. In some examples, each R^{A}, R^{B}, and R^{C} are the same or different and are a substituted or unsubstituted C₁₋₁₂ alkyl, a substituted or unsubstituted C₁₋₁₂ aryl, or hydrogen, provided that no more than one of R^{A}, R^{B}, and R^{C} are hydrogen. In some examples, each R^{A}, R^{B}, and R^{C} are the same or different and are an unsubstituted C₁₋₆ alkyl or a C₁₋₆ alkyl substituted with 1, 2, or 3 hydroxyl, halogen, nitrile, nitro, cyano, C₁₋₆ alkoxy, or amino groups of the formula —NR^{D}R^{E} wherein each R^{D} and R^{E} are the same or different and are a C₁₋₆ alkyl or C₁₋₆ alkoxy. In some examples, each R^{A}, R^{B}, and R^{C} are the same or different and are an unsubstituted C₁₋₄ alkyl or a C₁₋₄ alkyl substituted with one hydroxyl, halogen, nitrile, nitro, cyano, or C₁₋₃ alkoxy.

In some examples, the amine comprises triethylamine, trimethylamine, dimethylethanolamine, diethanolamine, or a combination comprising at least one of the foregoing. For example, the amine comprises triethylamine. For example, the amine comprises dimethylethanolamine. For example, the amine comprises diethanolamine.

The amine can be added to the polyimide precursor solution in an amount effective to solubilize the polyimide prepolymer in a C₁₋₆ alcohol, in a solution of the C₁₋₆ alcohol and deionized water, or in deionized water. For example, the amine can be present in the polyimide precursor solution in an amount of 5 to 50 wt. %, or 8 to 40 wt. %, or 9 to 35 wt. %, based on the combined weight of the amine and the dry weight of the polyimide prepolymer.

The amine can be added in an amount effective to solubilize the polyimide prepolymer in the alcohol, the mixture of the alcohol and water, or in water. In some examples, the solution can be heated at a temperature equal to the boiling point of the C₁₋₆ alcohol at atmospheric pressure, or at a temperature greater than 100° C. at a pressure greater than atmospheric pressure.

Solvent

The polyimide precursor solution includes a solvent, e.g., to dissolve the bisanhydride precursor compounds, the diamine precursor compounds, and the polyimide prepolymer. In some examples, the solvent is a protic organic solvent. Examples of protic organic solvents include, but are not limited to, a C₁₋₆ alcohol, wherein the C₁₋₆ alkyl group can be linear or branched. The C₁₋₆ alcohol can include methanol, ethanol, n-propanol, isopropanol, n-butanol, t-butanol, sec-butanol, 1-pentanol, 2-pentanol, 3-pentanol, 1-hexanol, 2-hexanol, 3-hexanol, 2-ethyl-1-butanol, 3-methyl-1-butanol, 3-methyl-2-butanol, 2-methyl-2-butanol, 2,2-dimethyl-1-propanol, ethylene glycol, diethylene glycol, or a combination comprising at least one of the foregoing. In some examples, the C₁₋₆ alcohol is substantially miscible with water. For example the C₁₋₆ alcohol can comprise methanol, ethanol, n-propanol, isopropanol, or a combination comprising at least one of the foregoing. In some examples, the solvent comprises methanol, ethanol, or a combination comprising at least one of the foregoing.

In some examples, the solvent further comprises water, for example deionized water. The solvent can include water in a weight ratio of C₁₋₆ alcohol:water of about 1:100 to about 100:1, such as about 1:10 to about 10:1, for example about 1:2 to about 2:1, such as about 1:1.1 to about 1.1:1. In other embodiments, however, no water is present. For example, the solvent can comprise less than 1 weight percent (wt. %), or is devoid of water.

In some examples, the solvent comprises less than 1 wt. %, or is devoid of harsher organic solvents, such as a chlorobenzene, a dichlorobenzene, cresol, dimethyl acetamide, veratrole, pyridine, nitrobenzene, methyl benzoate, benzonitrile, acetophenone, n-butyl acetate, 2-ethoxyethanol, 2-n-butoxyethanol, dimethyl sulfoxide, anisole, cyclopentanone, gamma-butyrolactone, N,N-dimethyl formamide, N-methyl pyrrolidone, tetrahydrofuran or a combination comprising at least one of the foregoing. In another embodiment, the solvent comprises less than 1 wt. %, or less than 0.1 wt. % of a nonprotic organic solvent, and in some examples the solvent is devoid of a nonprotic organic solvent. In another embodiment, the solvent comprises less than 1 wt. %, or less than 0.1 wt. %, of a halogenated solvent, and preferably the solvent is devoid of a halogenated solvent.

The polyimide precursor solution can comprise, based on the total weight of the compositions: from about 1 to about 90 wt. % of the polyimide prepolymer, such as from about 5 to about 80 wt. %, for example from about 10 to about 70 wt. % of the polyimide prepolymer; from about 10 to 99 wt. % of the solvent, such as from about 20 to about 95 wt. %, for example from about 30 to about 90 wt. % of the solvent; and from about 0 wt./% or about 0.001 wt. % to about 50 wt. % of the amine, such as from about 0.01 to about 30 wt. %, for example from about 0.01 to about 15 wt. % of the amine.

Other Additives

The polyimide precursor solution can further comprise additional components to modify the reactivity or processability of the compositions, or properties of the polyimides and articles formed from the polyimides. For example, the polyimide precursor solution can further comprise a polyimide chain-stopping agent to adjust the molecular weight of the polyimide. Examples of chain-stopping agents include, but are not limited to, monofunctional amines such as aniline and monofunctional anhydrides such as phthalic anhydride, maleic anhydride, or nadic anhydride. The chain-stopping agent can be present in an amount of 0.2 mole percent to 10 mole percent, more preferably 1 mole percent to 5 mole percent based on total moles of the bisanhydride precursor compounds or the diamine precursor compounds. In some examples, the polyimide prepolymer is partially endcapped with a chain-stopping agent. In another embodiment, however, no chain-stopping agent is present in the polyimide precursor solution.

In another embodiment, the polyimide precursor solution can further comprise a polyimide crosslinking agent. Such crosslinking agents are known, and include, compounds containing an amino group or an anhydride group and crosslinkable functionality, for example ethylenic unsaturation. Examples include, but are not limited to, maleic anhydride and benzophenone tetracarboxylic acid anhydride. The crosslinking agents can be present in an amount of 0.2 mole percent to 10 mole percent, more preferably 1 mole percent to 5 mole percent based on total moles of one of the bisanhydride precursor compounds or the diamine precursor compounds.

The polyimide precursor solution can further comprise a branching agent, for example a polyfunctional organic compound having at least three functional groups which can be, for example, amine, carboxylic acid, carboxylic acid halide, carboxylic anhydride, and mixtures thereof. A branching agent can be a substituted or unsubstituted polyfunctional C₁₋₂₀ hydrocarbon group having at least three of any one or more of the aforementioned functional groups. Exemplary branching agents can include a C₂₋₂₀ alkyltriamine, a C₂₋₂₀ alkyltetramine, a C₆₋₂₀ aryltriamine, an oxyalkyltriamine (e.g., JEFFAMINE T-403™ available from Texaco Company), trimellitic acid, trimellitic anhydride, trimellitic trichloride, and the like, and combinations comprising at least one of the foregoing. When present, the amount of branching agent can be 0.5 to 10 weight percent based on the weight of the polyimide prepolymer.

The polyimide precursor solution can further comprise a particulate polymer dispersible in the solvent, for example dispersible in the C₁₋₆ alcohol, in a solution of the C₁₋₆ alcohol and water, or in water. In some examples, the particulate polymers are preferably dispersible in water. Imidization of the polyimide prepolymer in the presence of the particulate polymer can provide an intimate blend of the polymer and the polyimide. The dispersible polymers can have an average particle diameter from 0.01 to 250 μm. Aqueous-dispersible polymers include, but are not limited to, fluoropolymers, (e.g., polytetrafluoroethylene, tetrafluoroethylene-perfluoroalkylvinylether copolymer, tetrafluoroethylene-hexafluoropropylene copolymer, polychlorotrifluoroethylene, tetrafluoroethylene-ethylene copolymer, polyvinylidene fluoride), (meth)acrylic and (meth)acrylate polymers (e.g., poly(methyl (meth)acrylate), poly(ethyl (meth)acrylate), poly(n-butyl (meth)acrylate), poly(2-ethyl hexyl (meth)acrylate), copolymers thereof, and the like), styrenic polymers (e.g., polystyrene, and copolymers of styrene-butadiene, styrene-isoprene, styrene-acrylate esters, and styrene-acrylonitrile), vinyl ester polymers (e.g., poly(vinyl acetate), poly(vinyl acetate-ethylene) copolymers, poly(vinyl proprionate), poly(vinyl versatate) and the like), vinyl chloride polymers, polyolefins (e.g., polyethylenes, polyproplyenes, polybutadienes, copolymers thereof, and the like), polyurethanes, polyesters (e.g., poly(ethylene terephthalate), poly(butylene terephthalate), poly(caprolactone), copolymers thereof, and the like), polyamides, natural polymers such as polysaccharides, or a combination comprising at least one of the foregoing.

When present, the dispersible polymers can be present in an amount of 0.1 to 50 wt. %, preferably 1 to 30 wt. %, more preferably from 5 to 20 wt. %, each based on the total weight of the precursor compounds in the composition.

The polyimide precursor solution can further comprise additives for polyimide compositions known in the art, with the proviso that the additive(s) are selected so as to not significantly adversely affect specified properties of the compositions, in particular formation of the polyimide. Such additives include a particulate filler (such as glass, carbon, mineral, or metal), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. In general, the additives are used in the amounts generally known to be effective. For example, the total amount of the additive composition can be 0.001 to 10.0 wt. %, or 0.01 to 5 wt. %, each based on the total weight of the precursor compounds in the composition.

For example, a combination of a heat stabilizer, mold release agent, and ultraviolet light stabilizer can be used. Pigments, surface effect agents, and nanosized fillers are also specifically contemplated, as such materials can be readily co-dispersed with the precursor compounds, or pre-combined with the precursor compounds. When present, the nanosized fillers can be present in an amount of 0.1 to 50 wt. %, preferably 1 to 30 wt. %, more preferably from 2 to 10 wt. %, each based on the total weight of the precursor compounds in the composition.

Conversion to Polyimide

The polyimide precursor solution can be used in the formation of a polyimide precursor powder or gel that can be converted to a polyimide. The polyimide precursor powder or gel can be converted to a polyimide article by heating the precursor at a temperature and for a period of time effective to imidize the polyimide prepolymer and form the polyimide. Suitable temperatures are greater than or equal to about 250° C., such as from about 250 to about 500° C., for example from about 300 to about 450° C. The polyimide precursor solution can be heated for a time from 10 minutes to 3 hours, such as from 15 minutes to 1 hour. The imidization can be conducted under an inert gas during the heating. Examples of inert gasses that can be used include, but are not limited to, dry nitrogen, helium, argon and the like. Dry nitrogen is generally preferred. In an advantageous feature, such blanketing is not required. The imidization is generally conducted at atmospheric pressure.

If present, the solvent to be removed from the printed polyimide precursor solution during the imidization, or the solvent can be removed from the printed polyimide precursor solution before the imidization, for example by heating to a temperature below the imidization temperature. The solvent can be partially removed, or can be fully removed.

If a crosslinker is present in the polyimide precursor solution, crosslinking can occur before the imidization, during the imidization, or after the imidization. For example, when the crosslinker comprises ethylenically unsaturated groups, the printed polyimide precursor solution can be crosslinked by exposure to ultraviolet (UV) light, electron beam radiation or the like, to stabilize the printed polyimide precursor solution. Alternatively, the polyimide can be post-crosslinked to provide additional strength or other properties to the polyimide.

Depending on the precursor compounds and other materials used in the polyimide precursor solution, the polyimides can have a melt index of 0.1 to 10 grams per minute (g/min), as measured by American Society for Testing Materials (ASTM) D1238 at 340 to 370° C., using a 6.7 kilogram (kg) weight. In some examples, the polyimide has a weight average molecular weight (MW) of greater than 1,000 grams/mole (Daltons), or greater than 5,000 Daltons, or greater than 10,000 Daltons, or greater than 50,000 Daltons, or greater than 100,000 Daltons as measured by gel permeation chromatography, using polystyrene standards. For example, the polyimide can have a weight average molecular weight (MW) of 1,000 to 150,000 Daltons. In some examples the polyimide has a MW of 10,000 to 80,000 Daltons, specifically greater than 10,000 Daltons or greater than 60,000 Daltons, up to 100,000 or 150,000 Daltons. In some examples, the polyimide has a molecular weight that is no more than 10% lower than the molecular weight of the same polyimide formed in the absence of the amine. The polyimides can further have a polydispersity index of 2.0 to 3.0, or 2.3 to 3.0.

The polyimides can further be characterized by the presence of less than 1 wt. %, or less than 0.1 wt. % of a nonprotic organic solvent. In some examples, it is preferred that the polyimide is devoid of a nonprotic organic solvent. Similarly, the polyimide has less than 1 wt. %, or less than 0.1 wt. % of a halogenated solvent, and preferably the polyimide is devoid of a halogenated solvent. Such properties are particularly useful in layers or conformal coatings having a thickness from 0.1 to 1500 μm, specifically 1 to 500 μm, more specifically 5 to 100 μm, and even more specifically 10 to 50 μm.

The methods of manufacturing polyimides and articles comprising the polyimides described herein do not rely on organic solvents, and allows for very small droplets, which can allow for thin layers of the polyimide to be obtained. The method is useful not only for layers and coatings, but also for forming composites. Therefore, a substantial improvement in methods of manufacturing polyimides and articles prepared therefrom is provided.

Set forth below are some examples of the system and method disclosed herein.

### Embodiment 1

A system for fabricating an article, the system comprising: a build area; a precursor feed system to feed a polyimide precursor (preferably at least two polyimide precursors) to a build area; and a laser system comprising a laser device to emit a focused energy beam onto the build area, and a laser actuator to aim the focused energy onto selected target locations of the build area in order to selectively initiate polymerization of at least a portion of the polyimide precursor into a structure including polyimide.

### Embodiment 2

The system of Embodiment 1, wherein the polyimide precursor comprise at least one of a polyimide precursor powder and a polyimide precursor gel.

### Embodiment 3

The system of either one of Embodiments 1 or 2, wherein the polyimide precursor comprise at least one of: a bisanhydride precursor compound, a diamine precursor compound, and a reaction product of a bisanhydride precursor compound and a diamine precursor compound.

### Embodiment 4

The system of any one of Embodiments 1-3, wherein the polyimide precursor comprises a polyimide precursor powder comprising at least one of: powder particles of a reaction product of a bisanhydride precursor compound and a diamine precursor compound; and a dry powder mixture of bisanhydride precursor compound particles and diamine precursor compound particles.

### Embodiment 5

The system of either one of Embodiments 3 or 4, wherein the reaction product is formed by a process comprising at least one of (preferably comprising one of): dissolving the bisanhydride precursor compound and the diamine precursor compound in water in the presence of a secondary or tertiary amine to provide the polyimide precursor; dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the polyimide precursor; or dissolving a bisanhydride precursor compound and a diamine precursor compound in a mixture of water and an aliphatic alcohol to provide the polyimide precursor.

### Embodiment 6

The system of Embodiment 5, wherein the bisanhydride precursor compound and the diamine precursor compound are dissolved in a substantially equimolar ratio.

### Embodiment 7

The system of any one of Embodiments 4-6, wherein the laser system is configured to melt and fuse powder particles together.

### Embodiment 8

The system of any one of Embodiments 4-7, further comprising a solvent feed system for selectively depositing a solvent onto the build area to at least partially dissolve at least a selected portion of the polyimide precursor powder.

### Embodiment 9

The system of Embodiment 8, wherein the laser actuator directs the focused energy beam to the location of the selective deposition of the solvent to provide for polymerization of the at least partially dissolved polyimide precursor powder.

### Embodiment 10

The system of any one of Embodiments 3-9, further comprising a catalyst feed system to selectively deposit a catalyst to the build area, wherein the catalyst initiates or speeds up polymerization of the polyimide precursor.

### Embodiment 11

The system of any one of Embodiments 1-10, wherein the polyimide precursor comprises a first one of a bisanhydride precursor compound and a diamine precursor compound, the system further comprising a second precursor feed system for selectively depositing a solution comprising a second one of the bisanhydride precursor compound and the diamine precursor compound in a solvent onto the build area to provide contact between the solution and the first one of the bisanhydride precursor compound and the diamine precursor compound.

### Embodiment 12

A method of fabricating an article, the method comprising: feeding a polyimide precursor to a build area; and selectively directing a focused energy beam to the build area to selectively initiate polymerization of at least a portion of the polyimide precursor into a structure including polyimide.

### Embodiment 13

The method of Embodiment 12, wherein the polyimide precursor comprises at least one of a powder and a gel.

### Embodiment 14

The method of either one of Embodiments 12 or 13, wherein the polyimide precursor comprises at least one of a bisanhydride precursor compound, a diamine precursor compound, and a reaction product of a bisanhydride precursor compound and a diamine precursor compound.

### Embodiment 15

The method of any one of Embodiments 12-14, wherein the polyimide precursor comprises a powder comprising at least one of: particles of a reaction product of a bisanhydride precursor compound and a diamine precursor compound; and a dry powder mixture of bisanhydride precursor compound particles and diamine precursor compound particles.

### Embodiment 16

The method of either one of Embodiments 14 or 15, wherein the reaction product is formed by a process comprising one of: dissolving the bisanhydride precursor compound and the diamine precursor compound in water in the presence of a secondary or tertiary amine to provide the polyimide precursor; dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the polyimide precursor; or dissolving a bisanhydride precursor compound and a diamine precursor compound in a mixture of water and an aliphatic alcohol to provide the polyimide precursor.

### Embodiment 17

The method of any one of Embodiments 14-16, wherein the bisanhydride precursor compound and the diamine precursor compound are dissolved in a substantially equimolar ratio.

### Embodiment 18

The method of any one of Embodiments 12-17, further comprising selectively depositing a solvent onto the build area to at least partially dissolve at least a portion of the powder mixture.

### Embodiment 19

The method of any one of Embodiments 12-18, further comprising selectively depositing a catalyst to the build area, wherein the catalyst initiates or speeds up polymerization of the polyimide precursor.

### Embodiment 20

The method of any one of Embodiments 12-19, wherein the polyimide precursor comprises a first one of a bisanhydride precursor compound and a diamine precursor compound, the method further comprising selectively depositing a solution comprising a second one of the bisanhydride precursor compound and the diamine precursor compound in a solvent onto the build area to provide contact between the solution and the first one of the bisanhydride precursor compound and the diamine precursor compound.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects or a requirement of order.

Method examples described herein can be machine or computer-implemented, at least in part, such as with a computer or machine-readable medium encoded with instructions to configure an electronic device to perform method steps as described in the above examples. An implementation of such methods can include code, e.g., microcode, assembly language code, a higher-level language code. Such code can include computer-readable instructions to perform method steps. The code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

1. A system for fabricating an article, the system comprising:
a build area;
a precursor feed system to feed a polyimide precursor to a build area; and
a laser system comprising a laser device to emit a focused energy beam onto the build area, and a laser actuator to aim the focused energy onto selected target locations of the build area in order to selectively initiate polymerization of at least a portion of the polyimide precursor into a structure including polyimide.

2. The system of claim 1, wherein the polyimide precursor comprise at least one of a polyimide precursor powder and a polyimide precursor gel.

3. The system of claim 1, wherein the polyimide precursor comprise at least one of a bisanhydride precursor compound, a diamine precursor compound, and a reaction product of a bisanhydride precursor compound and a diamine precursor compound.

4. The system of claim 1, wherein the polyimide precursor comprises a polyimide precursor powder comprising at least one of:
powder particles of a reaction product of a bisanhydride precursor compound and a diamine precursor compound; and
a dry powder mixture of bisanhydride precursor compound particles and diamine precursor compound particles.

5. The system of claim 3, wherein the reaction product is formed by a process comprising one of:
dissolving the bisanhydride precursor compound and the diamine precursor compound in water in the presence of a secondary or tertiary amine to provide the polyimide precursor;
dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the polyimide precursor; or
dissolving a bisanhydride precursor compound and a diamine precursor compound in a mixture of water and an aliphatic alcohol to provide the polyimide precursor.

6. The system of claim 5, wherein the bisanhydride precursor compound and the diamine precursor compound are dissolved in a substantially equimolar ratio.

7. The system of claim 4, wherein the laser system is configured to melt and fuse powder particles together.

8. The system of claim 4, further comprising a solvent feed system for selectively depositing a solvent onto the build area to at least partially dissolve at least a selected portion of the polyimide precursor powder.

9. The system of claim 8, wherein the laser actuator directs the focused energy beam to the location of the selective deposition of the solvent to provide for polymerization of the at least partially dissolved polyimide precursor powder.

10. The system of claim 3, further comprising a catalyst feed system to selectively deposit a catalyst to the build area, wherein the catalyst initiates or speeds up polymerization of the polyimide precursor.

11. The system of claim 1, wherein the polyimide precursor comprises a first one of a bisanhydride precursor compound and a diamine precursor compound, the system further comprising a second precursor feed system for selectively depositing a solution comprising a second one of the bisanhydride precursor compound and the diamine precursor compound in a solvent onto the build area to provide contact between the solution and the first one of the bisanhydride precursor compound and the diamine precursor compound.

12. A method of fabricating an article, the method comprising:
feeding a polyimide precursor to a build area; and
selectively directing a focused energy beam to the build area to selectively initiate polymerization of at least a portion of the polyimide precursor into a structure including polyimide.

13. The method of claim 12, wherein the polyimide precursor comprises at least one of a powder and a gel.

14. The method of claim 12, wherein the polyimide precursor comprises at least one of a bisanhydride precursor compound, a diamine precursor compound, and a reaction product of a bisanhydride precursor compound and a diamine precursor compound.

15. The method of claim 12, wherein the polyimide precursor comprises a powder comprising at least one of:
particles of a reaction product of a bisanhydride precursor compound and a diamine precursor compound; and
a dry powder mixture of bisanhydride precursor compound particles and diamine precursor compound particles.

16. The method of claim 14, wherein the reaction product is formed by a process comprising one of:
dissolving the bisanhydride precursor compound and the diamine precursor compound in water in the presence of a secondary or tertiary amine to provide the polyimide precursor;
dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the polyimide precursor; or
dissolving a bisanhydride precursor compound and a diamine precursor compound in a mixture of water and an aliphatic alcohol to provide the polyimide precursor.

17. The method of claim 14, wherein the bisanhydride precursor compound and the diamine precursor compound are dissolved in a substantially equimolar ratio.

18. The method of claim 12, further comprising selectively depositing a solvent onto the build area to at least partially dissolve at least a portion of the powder mixture.

19. The method of claim 12, further comprising selectively depositing a catalyst to the build area, wherein the catalyst initiates or speeds up polymerization of the polyimide precursor.

20. The method of claim 12, wherein the polyimide precursor comprises a first one of a bisanhydride precursor compound and a diamine precursor compound, the method further comprising selectively depositing a solution comprising a second one of the bisanhydride precursor compound and the diamine precursor compound in a solvent onto the build area to provide contact between the solution and the first one of the bisanhydride precursor compound and the diamine precursor compound.
